(19) United States
(12) Patent Application Publication
(10) Pub. No.: US 2025/0038530 A1
(43) Pub. Date: Jan. 30, 2025

(54) Intelligent Energy Management Systems and Methods

(71) Applicant: Intertrust Technologies Corporation, Berkeley, CA (US)

(72) Inventors: Eric Swenson, Soquel, CA (US); Michael Manente, Sudbury, MA (US)

(73) Assignee: Intertrust Technologies Corporation, Berkeley, CA (US)

(21) Appl. No.: 18/783,313

(22) Filed: Jul. 24, 2024

Related U.S. Application Data
(60) Provisional application No. 63/515,308, filed on Jul. 24, 2023.

(51) Int. Cl. H02J 3/00

(52) U.S. Cl. CPC H02J 3/0075; H02J 3/003; H02J 3/004; H02J 2300/40

(57) ABSTRACT

Embodiments of the disclosed systems and methods provide allow for dynamic management of electrical systems using an intelligent energy management system. Consistent with embodiments disclosed herein, an intelligent energy management system may allow for the dynamic connection of electrical sources and/or loads in accordance with applicable operating rules. Operating rules may be articulated and enforced by the intelligent energy management system that provide for event and/or state driven of an electrical system and/or associated sources and/or loads. Among other things, embodiments of the disclosed intelligent energy management system may support relatively flexible connection of electrical sources and loads, bidirectional energy usage to allow for energy to be both consumed from and fed back to a utility grid, improved battery storage and/or management, proactive energy source switching and predictive battery discharge management, and/or the like.

### CROSS-REFERENCE TO RELATED APPLICATIONS

This application claims the benefit of priority under 35 U.S.C. § 119 (e) to U.S. Provisional Application No. 63/515,308, filed Jul. 24, 2023, and entitled “Intelligent Energy Management Systems and Methods,” which is hereby incorporated by reference in its entirety.

### COPYRIGHT AUTHORIZATION

Portions of the disclosure of this patent document may contain material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### SUMMARY OF THE INVENTION

The present disclosure relates generally to systems and methods for managing energy systems. More specifically, but not exclusively, the present disclosure relates to systems and methods for managing energy generation, sources, and/or loads in an intelligent and coordinated manner.

In the area of home and business energy management, conventional solutions allow transferring of electrical load between the electrical grid and generation and/or sources including, for example and without limitation, electrical generators, solar panels, batteries, and/or the like. Some of these solutions may be in the form of manual transfer switches, where an operator manually disconnects the electrical grid from the main breaker panel at a home and/or business, and in so doing, allows for a backup source of electrical power, such as a generator, to feed the main breaker panel.

Automatic transfer switches, which may be combined into electrical smart meters, can sense when a power outage occurs from the electrical grid, and can disconnect the electrical grid from the load (e.g., disconnecting a home or business circuit breaker panel), and even start up a generator, connecting it to the load. Some of these automatic transfer switches can continue to monitor the electrical grid power supply and when power is restored, can disconnect the alternate source of power from the load, and reconnect the electrical grid to that load.

In addition, there are conventional solutions for connecting electric vehicle (“EV”) chargers in homes and/or businesses to the electrical grid, such that an EV can be charged on a schedule and/or to some percentage of full charge. Some of these conventional solutions support bidirectionality, where the EV batteries can be both charged from the grid, and alternatively be discharged to the grid when the charge is no longer needed, or in response to a demand response (DR) command from the grid. Conventional energy management solutions do not, however, allow homes and/or businesses to allow for more dynamic interconnection of multiple sources of electricity such as, for example and without limitation, the grid, generators, batteries, solar panels, wind turbines, and/or the like, with one or more loads (e.g., circuit breaker panels, EV chargers, batteries).

Embodiments of the disclosed systems and methods provide for techniques for dynamic management of electrical systems including electrical sources and/or loads. In various embodiments, an intelligent energy management system (“IEMS”) may be used for dynamic management of electrical systems consistent with various aspects of the disclosed systems and methods. In certain implementations, an IEMS may comprise a smart device supporting the connection and/or configuration of multiple energy sources and multiple loads to provide a cost-effective and/or flexible system.

An IEMS consistent with certain embodiments disclosed herein may offer a user (e.g., a home and/or business owner) a variety of benefits including, for example and without limitation, one or more of:
The ability to combine multiple electrical energy sources, including AC and DC sources.
The support of bidirectional energy usage to allow for energy to both be consumed from the grid and be fed back to the grid.
The support of flexible connection of electrical sources to one or more electrical loads (e.g., circuit breaker panels, batteries, EV chargers, etc.).
A rules-based execution engine that allows default and/or user-programmable rules to provide granular operations such as, for example and without limitation, connecting a source to a load, detecting when batteries reach a desired charge level and/or rerouting their electrical source to another load, predicting changes in weather and/or electricity costs to minimize those electricity charges, and/or other capabilities described herein.
Improved battery management allowing batteries to operate as both electrical sources (when discharging) and electrical loads (when charging), maintain certain charge levels that, once reached, allow for powering segments of a home and/or business and/or to feed energy back to the grid until reaching a specified charge level, at which time they may become loads again and charge from other available electrical sources.
Proactive energy source switching and predictive battery discharge management enabling energy consumers to use predicted availability of renewable energy and their consumption patterns to intelligently manage local battery storage (e.g. to discharge their stored energy to operate loads on premises during times when grid supplied power is “dirty” (i.e. large fraction is sourced from non-renewable sources) in advance of a predicted time period when a high percentage of power will be from renewable sources.

It will be appreciated that embodiments of the disclosed systems and methods may provide a variety of other benefits in a variety of use cases, and that any improvements, benefits, examples, and/or use cases described herein, including those detailed above, should be viewed as illustrative and not limiting.

### BRIEF DESCRIPTION OF DRAWINGS

The inventive body of work will be readily understood by referring to the following detailed description in conjunction with the accompanying drawings, in which:

FIG. 1 illustrates a non-limiting example of an IEMS hardware architecture consistent with certain embodiments disclosed herein.

FIG. 2 illustrates a non-limiting example of an IEMS software architecture consistent with certain embodiments disclosed herein.

FIG. 3 illustrates a non-limiting example of an initial state of a system implementing an IEMS in an example operational scenario consistent with certain embodiments disclosed herein.

FIG. 4 illustrates a conceptual diagram of a non-limiting example of a sequence of operations of an IEMS in an example operational scenario consistent with certain embodiments disclosed herein.

FIG. 5 illustrates a non-limiting example of a state of a system implementing an IEMS with the solar panels feeding the EV charger in an example operational scenario consistent with certain embodiments disclosed herein.

FIG. 6 illustrates a conceptual diagram of a non-limiting example of a sequence of operations of an IEMS to transition back to an initial state in an example operational scenario consistent with certain embodiments disclosed herein.

FIG. 7 illustrates a non-limiting example of stakeholders and/or entities that may interact with an IEMS consistent with various embodiments disclosed herein.

FIG. 8 illustrates a non-limiting example of interactions initiated by a rules execution engine consistent with certain embodiments disclosed herein.

FIG. 9 illustrates a non-limiting example of an initial state of a managed system consistent with certain embodiments disclosed herein.

FIG. 10 illustrates a non-limiting example of a state of a managed system after executing a first operational rule consistent with certain embodiments disclosed herein.

FIG. 11 illustrates a non-limiting example of a state of a managed system after executing a second operational rule consistent with certain embodiments disclosed herein.

FIG. 12 illustrates a non-limiting example of a state of a managed system after executing a third operational rule consistent with certain embodiments disclosed herein.

FIG. 13 illustrates a non-limiting example of a state of a managed system after executing a fourth operational rule consistent with certain embodiments disclosed herein.

FIG. 14 illustrates a non-limiting example of the operation of an IEMS rule execution engine consistent with certain embodiments disclosed herein.

FIG. 15 illustrates a non-limiting example of anomaly detection operations by an IEMS supervisor consistent with certain embodiments disclosed herein.

FIG. 16 illustrates a flow chart of a non-limiting example of a method of managing an energy system consistent with certain embodiments disclosed herein.

FIG. 17 illustrates a non-limiting example of a system that may be used to implement certain embodiments of the systems and methods of the present disclosure.

### DETAILED DESCRIPTION OF THE INVENTION

A description of systems and methods consistent with embodiments of the present disclosure is provided herein. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

The embodiments of the disclosure may be understood by reference to certain drawings. The components of the disclosed embodiments, as generally described and/or illustrated in the figures herein, could be arranged and designed in a wide variety of different configurations. Thus, the following description of the embodiments of the systems and methods of the disclosure is not intended to limit the scope of the disclosure, but is merely representative of possible embodiments of the disclosure. In addition, the steps of any method disclosed herein do not necessarily need to be executed in any specific order, or even sequentially, nor need the steps be executed only once, unless otherwise specified. Moreover, it will be understood that, as used herein, a process and/or method step that is described as being based on some information is not necessarily exclusively based on that information, but indeed may be based at least in part on the information and/or a portion thereof and/or other information.

While conventional energy management solutions may allow for transferring of loads from an electrical grid to an alternative power source (e.g., solar panels, a backup battery system, and/or the like) and reconnecting loads back to an electrical grid when power is restored, they may be limited in their ability to allow for multiple sources of power to be used simultaneously. Consistent with various embodiments disclosed herein, an IEMS may be used in connection with electrical power management. Consistent with various disclosed embodiments, an IEMS may comprise a hardware and/or software-based device with an onboard computer running an IEMS supervisor. In some embodiments, a physical IEMS may be a collection of hardware modules, which may include a primary device, and/or add-on hardware/software extension modules. In certain embodiments, an IEMS may be packaged as a replacement to an existing, or newly installed, electrical meter. In other embodiments, the IEMS may be connected to an electrical meter (e.g., a smart meter, or the older variety of meters). In other embodiments, the IEMS may be connected to or integrated within an electrical distribution box such as a circuit breaker, main distribution panel, and/or sub-panel (e.g., “behind the meter”). In some implementations, an IEMS may be provided by an electrical energy provider and/or installed in new buildings by electrical contractors.

### Dynamic Connection of Electrical Sources

As discussed above, an IEMS may allow for the connection of an arbitrary number of AC or DC sources of electricity. In some embodiments, a base IEMS device may limit the number of sources, but allow for expansion units to be added to the system, as new sources of electricity are installed by a home or business owner. This may be accomplished by an expandable set of connectors for both sources of electricity and loads. In some embodiments, the IEMS may provide certain smart meter functionality. It may communicate bi-directionally with the electricity grid over radio and/or any other network technology and/or combinations of technologies (e.g., ZigBee) and/or may accept and act on demand response (“DR”) commands issued from the grid (e.g., issued by transmission operators and/or electricity aggregators).

Using any suitable communication technology and/or standard and/or combinations thereof, an IEMS can deliver meter usage information to the electrical providers and/or other stakeholders. In some embodiments, an IEMS may automatically disconnect the electricity grid during power outages and/or automatically reconnect the grid when power is restored. This functionality may facilitate safer operation for electric grid line workers, who, when working on the transmission lines, need to be confident that they are not energized.

While conventional energy management solutions generally switch electrical supply between the grid and a backup power source such as a generator, and connect one or the other to a single load (e.g., usually the main circuit breaker panel), an IEMS consistent with various aspects of the disclosed embodiments can connect many different sources of electricity (e.g. the grid, generators, batteries, solar panels, wind turbines, etc.) and can support multiple distinct loads (e.g. the main circuit breaker panel, alternate panels for different functions, batteries, EV chargers, etc.). In some embodiments, an IEMS can sense the presence of electricity from multiple sources, and safely connect/disconnect the loads from these sources.

Connecting AC sources of electricity may involve synchronization operations, meaning that their frequency, phase, and voltage may be synchronized, within some tolerances. Conventional solutions for AC synchronization can combine two sources of AC power and use sophisticated microcontroller-based logic in order to safely perform the synchronization. DC sources may be combined if their voltages are matched. Consistent with embodiments disclosed herein, an IEMS can combine DC sources of electricity, such as solar panels and batteries, and then use an inverter to convert to AC. It can then use an embedded AC synchronizer, to synchronize the converted AC to the AC from the grid. If there are multiple AC sources, such as what one might have with wind turbines, each of these may be pairwise synchronized, and then the resulting AC sources will be synchronized with the grid. The process of AC synchronization may, in some implementations, take time (sometimes on the order of minutes). Once synchronized, AC sources may tend to stay synchronized, but microcontroller-based circuitry in an IEMS may continue to monitor for shifts in frequency and voltage in order to adjust these and/or or disconnect sources that fall out of synchronization.

### Dynamic Connection of Electrical Loads

In addition to combining multiple sources of electricity, an IEMS consistent with various aspects of the disclosed embodiments can also dynamically connect to one or more loads. In certain implementations, these loads may be in the form of distinct circuit breaker panels. EVs and battery chargers, however, can also function as separate loads (as well as sources of electricity). Circuitry in the IEMS may allow multiple loads to be connected separately, and logic in the IEMS can switch between electricity supply and loads as programmed and controlled in software. In some embodiments, software-configured rules can be established to instruct the IEMS how to connect the various sources to the various loads. For example, it may be that the main circuit breaker panel should normally be connected to the electrical grid, but the owner may wish to use solar or wind electricity to charge up an EV. When the solar or wind electricity is insufficient (and/or predicted to be insufficient) to keep the EV charged to desired levels at desired times, then electricity from the grid can be used to augment charging.

In another non-limiting illustrative example leveraging multiple sources of electricity, a solar panel providing 6 kW of electrical power on a bright, sunny day, may be connected to a load demanding approximately 6 kW of electrical power. On sunny days an IEMS consistent with various disclosed embodiments can connect the solar panels to the load. However, when the solar power generation drops below the demands of the load, the IEMS can safely augment the power supply to the load by shifting the appropriate amount of energy from the grid to make up the difference. This is an example of aggregating multiple sources of electricity—a function that conventional transfer switches typically do not perform, as they simply switch between one or more sources, rather than combining electrical power generated by multiple sources.

### IEMS Connectivity

Being a hardware/software solution, an IEMS consistent with various aspects of the disclosed embodiments may also have certain network connectivity. For example and without limitation, an IEMS may connect to the Internet and/or an Intranet and/or another local network. External connections may allow API access to the functions of the IEMS, access to a management web interface of the IEMS, and leveraging external services to access information (e.g., current and/or predicted indications of weather, electricity prices, percentage of energy from renewable sources, availability of renewable sources, oversupply of renewable sources, etc.) and/or send messages (e.g., alerts) to external parties and/or services. Network capabilities of the IEMS may allow connectivity from authorized users via smartphone and PCs. Once connected these users may query the status, control the operation, and even view, modify, and/or delete operational rules governing certain functions of the IEMS. They may also be alerted when the IEMS detects conditions that warrant notifying external parties and/or services.

IEMS network access also allows DR commands to be received and/or acknowledged. Moreover, audit logs of operations performed by an IEMS may be sent to authorized external parties and/or services via network connections.

### IEMS and Operational Rules Overview

An IEMS consistent with various disclosed embodiments may implement a rule-based engine that leverages operational rules to customize and/or otherwise manage its operation. Operational rules may, for example and without limitation, dictate and/or otherwise specify electricity combinations (e.g., permitted and/or available combinations of sources), and/or or connections between sources and loads, which may be based on the occurrence of certain events and/or conditions. The rules engine may also leverage network connectivity of the IEMS to evaluate conditions under which rules may be executed. For example and without limitation, rules may query the current or predicted weather conditions and/or the current or projected electricity costs and/or the current or projected availability of renewable energy to determine whether certain operations of the IEMS should be executed.

In various embodiments, an IEMS may leverage artificial intelligence (“AI”) and/or machine learning methods to “learn” about the energy needs and supplies of a given home or business. In some IEMS embodiments, an AI/machine Learning module may come pre-installed in an IEMS. In further embodiments, this capability may be provided via an add-on module, downloaded, and installed by an authorized user of the IEMS. An AI/machine learning module may connect to the Internet (or Intranet, or other radio-based destinations) to learn about the weather, electricity costs, and/or characteristics of the grid energy being provided (e.g. percent supplied by renewable sources) and use predictive analytics based on prior usage and/or events to suggest additional operational rules to make better and more efficient use of electricity to meet specified cost and/or renewable energy objectives. In further embodiments, the IEMS may include a module for communicating with a remotely hosted AI service to suggest operational rules based on a model built from similar users' data and/or a model built from usage and/or event data collected by the IEMS and/or other devices in the IEMS's energy domain (e.g. smart appliances, etc.)

### IEMS and User Accounts

In certain embodiments, the IEMS may support the establishment of user accounts. In some embodiments, multiple user accounts may be used, such as for other family members besides the owner, other members of the business, and/or certified service personnel. Permission rules that may be associated with accounts may define what rights each of these stakeholders have—that is, what operations they can perform regarding the configuration of the IEMS, what sources and loads they can connect, disconnect, and/or monitor, and/or the ability to create, update, and/or or delete operational rules and/or permission rules associated with accounts.

IEMS user accounts can be created for external parties/stakeholders, such as a grid operator and/or electricity aggregators. Permission rules associated with accounts can restrict exactly what operations these external stakeholders can perform. If allowed, and potentially within certain limits established by the permission rules, these external stakeholders may create, update, and/or delete operational rules as well.

### Operational Rules Example—Predicted Weather

Operational rules and/or weather prediction information can inform the operation of an IEMS, with a result of cost benefits to the owner of a home and/or business. In a non-limiting example, a customer's energy needs may be constant over a week, but the weather at the start of the week may be hot and sunny. As such, energy costs may be high because demand may be high. At the end of the week, the weather may be predicted to change to cool and cloudy, with associated energy costs being lower due to decreased demand. At the start of the week, the customer's solar panels and/or connected batteries (either standalone, such as with an in-home battery storage system or in an EV vehicle or fleet of such vehicles) could supply a significant amount of electricity, and at the end of the week, would not be able to deliver much electricity.

At the start of the week, the customer's home and/or business might want to leverage the solar panels for electricity to realize cost savings, but at the end of the week, they may use the electricity grid. The IEMS can anticipate the changes (e.g., based on weather predictions) and incorporate this information into the planning for how much electricity to consume from the solar panels/batteries and how much to consume from the grid. Operational rules may control this kind of dynamic configuration. An AI and/or machine learning module may be configured to alert the IEMS owner of proposed operational rules and/or can be granted the ability to create rules on its own, within limits defined by the IEMS owner.

### Predictive Analytics and Machine Learning Example

In another non-limiting example, machine learning and predictive analytics may be leveraged to proactively plan electrical use and/or charging. For example, if the weather today is moderate, but it is predicted that it will be sunny and windy in two days, an IEMS could start discharging batteries to power the home, so that there is sufficient storage capacity when renewable energy (e.g., sun/wind) is available. Similar smart logic can drive which mix of electricity sources are connected to the loads, and which sources are feeding electricity back into the grid to reduce a customer's electricity charges. The IEMS can learn a customer's usage (as well as the grid's electricity costs and renewable energy mix) to optimize the choices among multiple energy sources.

IEMS and Connected Devices and/or Appliances

Consistent with embodiments disclosed herein, an IEMS can leverage smart home/business appliances such as, for example and without limitation, thermostats, freezers, refrigerators, and/or washers/dryers. When energy demands on the electricity grid are high and costs are high, commands can be sent to the devices, subject to operational rules (e.g., rules authored by the owner of the IEMS), to reduce the thermostat temperature settings on cold days or increase the temperature settings on hot days. It can (potentially within bounds set by the owner) increase the temperature in freezers and refrigerators and/or drop the temperature of ovens and dryers. Because the IEMS may, in some embodiments, support the Matter standard for home automation, it can leverage the Matter infrastructure to control those devices, through the operations defined in operational rules.

In embodiments where the IEMS is connected to the electrical grid, the IEMS may support DR commands and/or status queries from the electrical grid. Commands from the grid to reduce consumption, for example, may, through operational rules in the IEMS, translate to control the times, durations, and/or voltage/power consumption of various loads in a customer's home and/or business. For example, the electrical grid operator may wish to lower and/or raise the thermostat to control the heating and air conditioning in times of high electrical load or low grid capacity. Similarly, the electrical grid operator may wish to modify the start time and duration of EV vehicle charging. Because the IEMS can support multiple electricity sources, it may handle DR commands by switching to alternate sources of electricity (e.g., battery, solar, wind, etc.) rather than altering the operation of the customer's appliances.

As another non-limiting variation, the IEMS may do the opposite, e.g., based on predictive weather inputs, it may forecast that DR messages are likely the following day. In preparation for such events, the home temperature and/or freezer temperature may be lowered in advance, thereby giving more opportunity to respond to the demand signal later since the freezer can stay off for longer in the afternoon without risk, and/or since the starting temperature of the contents was lower to begin.

The owner of the appliances and/or vehicles, on the other hand, may wish to limit the degree to which the electrical grid operator may control the use of the electricity; they may wish to simply pay more to have the electricity when they believe they need it. There may be times when the owner of the appliances is ok with control on behalf of the grid operator, and other times when they are not. For example, an EV car owner may commute to work each weekday, drive minimally on the weekend, and charge the car to capacity every night, so the owner may care about having sufficient reserve battery in the EV for some percentage over the foreseen driving on a given each day. The EV car owner may wish to allow the grid operator to modify the schedule and duration of charging, potentially within some limits. However, should the EV owner wish to go on a long drive occasionally, they may wish to override the grid operator's changes, and take manual control over the charging schedule.

Some EV car owners, out of range anxiety, may purchase EVs with batteries that provide far more capacity than they actually need on a regular basis. The thinking is that “I might need to drive a long distance,” even though the owner may do this very rarely. Coupled with a default charging schedule that keeps these EVs fully charged, an opportunity presents itself to leverage that excess capacity when electrical demand is high. As before, the EV owner may deny and/or limit the use of the excess energy when they actually do need the vehicle for a long trip. From an aggregate point-of-view, a grid operator that services many of these kinds of EV owners potentially has a lot of energy sources to leverage when needed. Because the IEMS may be situated between the grid operator and the customer's loads, it may issue DR commands to connected EV chargers and/or interpret the DR commands from the grid differently. For example and without limitation, the IEMS may reduce the consumption of electricity from the grid, and instead leverage other sources of power connected to the IEMS. As one non-limiting example, the IEMS may direct the vehicle's charger to cease charging the vehicle, and, depending upon the remaining charge level in the vehicle and IEMS user policy settings (including, but not limited to, time of day, minimum remaining charge limits, pricing information, weather forecasts, etc), the IEMS may connect certain loads to the vehicle charger and signal the charger to supply power from the vehicle battery.

Some household appliances may use a significant amount of electricity: ovens, dryers, furnaces, air conditioners are some examples. Within some limits, the owner of these appliances may be willing to allow some degree of control on the part of the grid operator over the usage or temperature settings of devices. However, there may be times when the owner wishes to prevent the grid operator from changing settings on these appliances. For example, if a family member is sick, the owner may wish to have the thermostat set for higher temperatures and prevent the grid operator from changing them. At other times, however, the owner may find grid operator control over the temperature acceptable.

While EVs may consume power from the electrical grid (e.g., through a charging station), and thus operate as electrical loads, they may also store energy. Excess energy can be discharged to power the customers loads and/or may be discharged to the electrical grid (e.g., to aid in times of high demand/load). The latter function may involve bi-directional EV chargers. Consistent with various embodiments disclosed herein, when connected to the IEMS, control over the flow of energy (in both directions) can be managed using the operational rules implemented by the IEMS. Using an IEMS situated within the premises, a user may configure operational rules that, under prescribed conditions, allow the IEMS to supply certain loads on the premises to receive power from energy stored in EVs, without necessarily supplying energy back to the grid.

Similarly, other storage devices may charge from the grid and can potentially be available to discharge through the grid when extra energy is needed. Batteries and in-home battery storage walls are non-limiting examples of such storage devices. In addition to storage devices, there are also electricity-generating devices, such as solar panels, wind turbines, and generators. While a consumer may wish to extract electrical power from these sources in times where their energy demands are high and/or as a means of offsetting the costs of consuming electricity from the grid, there may be other times when the consumer is willing to allow these devices to provide surplus electricity to the grid.

A symbiotic relationship between the consumer and the grid operator (and/or with electrical suppliers to the grid, such as from renewable energy sources) may allow for the grid to offload some of the surplus electricity, in return for some credits or discounts. Again, in these scenarios, there may be tension between when the consumer wishes to allow this use of their storage devices (and/or power generating devices), and when the grid operator wants or needs that energy. Embodiments of the disclosed systems and methods may allow for the owner of the resources to allow, disallow, and/or limit the degree to which the grid operator can take advantage of these resources.

As a non-limiting example using a power-generating appliance, a farmer may have one or more wind turbines on a farm that are used to power irrigation, lighting, and/or other farm systems. There may be times when they are willing to allow the grid operator to leverage these resources, and other times when they aren't. Consistent with embodiments disclosed herein, an IEMS may operate as the hub that connects these power-generating appliances and its operational rules and control logic can specify when and/or how these sources can feed back into the electrical grid and/or when they can be used to provide energy to the customer's other loads.

Another non-limiting example centers on enterprises that manage a fleet of EVs, such as car rental and/or delivery services. To handle the greatest demand on the use of their vehicles, they may need to purchase a number of vehicles that is greater than their needs at “low” demand times, but sufficient to meet their “high” demand times. At times when vehicle demand is lower, it may be possible to have stored energy diverted to the electrical grid when demand for electricity among customers of the grid operator is high. As before, the owner of the fleet of vehicles may be able to allow, disallow, and/or limit the control a grid operator has over the stored energy (and charging) of their EV fleet. This sharing of resources may allow for business models where the electrical grid (or some entity operating on its behalf) leases additional EVs to the fleet enterprise at a discount (or provides conditional funding to purchase vehicles), with the understanding that it can use the energy from these vehicles in times of high energy demand. The grid may experience more energy resilience, and the enterprise may operate more vehicles and benefit from increased operational resilience of their business. If, due to the enterprise placing too many limits on the grid's use of the energy, at the end of some lease period, it may have to pay some premium. Alternatively, if the grid operator determines that it received sufficient use of the EV energy, it could provide some rebates. In the case of fleets of EVs, there may be additional stakeholders in the picture, for example, fleet managers, and/or drivers. In some embodiments, if the EV charging stations, and their connected EVs, are connected to the IEMS as distinctly addressable loads, the IEMS can control when and how these EVs can supply energy back to the electrical grid.

### Virtual Power Plant DR Systems

Many virtual power plant (“VPP”) DR systems may support reducing electrical consumption based on signals received from the grid. For example, a thermostat can have the temperature settings lowered in cold months and raised in hot months. The thermostat can report that it acted on a demand request from the grid, allowing for credits or remunerations and/or other mechanisms to reward the customer for helping in times of high demand. However, there are other ways for a customer's home or business to react to a DR request. For example, if the customer has EVs or batteries, or other forms of energy generation, such as solar panels and/or wind turbines, in response from a request from the grid to reduce demand on the grid, these electricity-producing appliances can be directed to discharge into the customer's home or business, and thereby reduce the customer's load on the electrical grid. This, too, is an action that can be measured and rewarded by the electrical grid or VPP.

When a request to reduce load on the electrical grid is received by an IEMS consistent with various disclosed embodiments, the IEMS can decide what actions to take leveraging available the electricity sources and loads. When it does act on the command, it may leverage a secure and/or immutable log, to store these commands and responses. These logs may be uploaded to the grid operator, VPP, and/or electricity aggregator. If these logs cannot be uploaded for some reason (e.g., the network connection is down, upstream servers are down, etc.), they can be securely stored and delivered to the grid operator when the network connection is reestablished. The status of thermostats, generators, batteries, circuit breaker panels, smart appliances, etc., with the potential to act on DR requests from the VPP similarly, may be similarly logged with the IEMS that may operate as a broker.

Various stakeholders may be able, through Internet and/or other forms of communications, to control and monitor the various consumer or fleet appliances. However, consistent with various disclosed embodiments, the rights to perform these operations may need to be limited, granted, and/or denied by the customer who ultimately is impacted by such operations. For example, a customer may wish to limit access to control and query an appliance to a set of stakeholders for privacy reasons. Or perhaps the customer may wish to grant such access in return for remuneration or perks.

By having real-time grid-based energy pricing data injected into the IEMS at a home or business, a customer could leverage storage devices (e.g., batteries) as a form of arbitrage. When prices are low, they could charge up their batteries from the grid, and when prices are high, use the stored energy for their home or business. This mechanism could also be used to leverage EV battery storage when EV use is not planned or needed. Customers can buy storage devices and/or use existing EV batteries to provide power to the home when grid electrical costs are high, and charge these batteries when costs are low. In this manner, the batteries may be used as an insurance policy against high electricity costs.

Embodiments disclosed herein may beneficially provide a system that is aware of various stakeholders, electrical sources, and/or electrical loads (e.g. appliances), and can govern access between stakeholders and appliances. A secure, data/control governance infrastructure that allows rights to be granted, denied, limited, etc. may protect the customer and other stakeholders while also providing benefit to limited sharing of data and control. An IEMS web interface consistent with aspects of the disclosed embodiments may allow the customer to control access to various functions by these stakeholders and/or to create, update, delete, and/or monitor changes to the permission and operational rules that control its operation.

### IEMS Hardware Overview

Consistent with various embodiments disclosed herein, the IEMS may comprise a hardware device coupled with intelligent software and/or services that may be integrated with the hardware or communicatively coupled with it. The hardware portion may support the electrical connection of various sources and loads through a set of standardized connectors. It can combine sources of AC electricity through frequency, phase, and/or voltage synchronization. It can also combine sources of DC electricity by first ensuring the voltage of each source is equal and then connecting them in parallel. Voltage matching may occur in pairwise fashion, after first analyzing the voltages and currents of each DC source to be combined, and then reducing or increasing the voltage of the second to match the first. It can also combine the AC and DC sources using one or more pairwise synchronization steps, using micro-controlled circuitry. It can perform “transfer switch” functionality by electrically connecting or disconnecting each electrical source.

The IEMS hardware includes a microcontroller computer that runs the IEMS software. The software may include and leverage a rule-based execution engine to control the connection and disconnection of sources and loads. The IEMS may include hardware and a microcontroller to provide failsafe and non-overridable functions for electrical isolation—such as when a power outage occurs on the electricity grid, and alternate power sources connected to the IEMS need to be guaranteed to not be able to energize the transmission lines leading to the home or business.

In some embodiments, the IEMS can support expansion. For example, in certain embodiments, models of the IEMS can be produced that allow a fixed number of AC or DC sources to be connected and/or a limited number of loads. However, expansion modules can be purchased separately such that the number of sources or loads can be increased. This may allow for a relatively cost-effective hardware device that can grow with a customer's needs and demands.

As discussed in more detail below, the IEMS may include hardware to allow it to communicate with the outside world using, for example, Ethernet, WIFI, Bluetooth, Zigbee, Matter, and/or radio. This may allow the IEMS to be controlled via external devices (e.g., laptops, smart phones, external services, etc.) and/or monitoring from outside the IEMS hardware. This communications hardware may allow the IEMS software to leverage external services for information gathering (e.g., weather and electricity prices), security (e.g., checking the security status of devices connected to the IEMS, and that of firmware/software running on those devices), as well as other functions (e.g., implementing a digital twin and/or peer for configuration purposes).

### IEMS Hardware Architecture

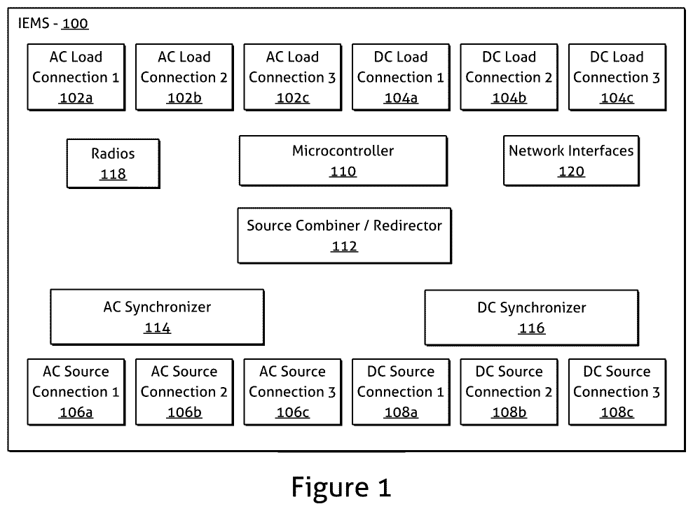

FIG. 1 illustrates a non-limiting example of an IEMS hardware architecture consistent with certain embodiments disclosed herein. Although various components of the architecture as shown in the figures are illustrated as separate components, it will be appreciated that the illustrated components may be combined and/or otherwise configured using any suitable number of components and/or subcomponents that may be coupled in various suitable configurations to facilitate the disclosed functionality of the IEMS 100.

### IEMS Hardware Architecture—AC Source Connections

In various embodiments, the IEMS 100 may comprise one or more AC source connections 106a-106c, which may vary in number based on the model and configuration of the IEMS 100, that may provide connection(s) to one or more AC electricity sources (e.g. the electric grid, wind turbines, etc.). In some embodiments, a fixed number of these connections may be found on a base IEMS device 100, with extension modules being able to provide additional AC connections. In this manner, the IEMS 100 may be expandable and/or otherwise configurable for scaling.

In some embodiments, the physical connection to sources outside the IEMS 100 may use a custom socket, allowing multiple kinds of connectors to electrical sources. In some embodiments, an AC source connection 106a-106c may comprise a circuit breaker, a current sensor, and/or a cutoff switch, with various components that may be controlled by a microcontroller.

When current is sensed, a signal may be sent to the microcontroller 110, which may cause an event to be signaled on an event bus (e.g., a software manifestation). When current is lost (e.g., as in a power outage), a cutoff switch in an AC source connection 106a-106c may automatically disconnect the source connection from the rest of the IEMS 100 (specifically to the AC synchronizer) to ensure that any current flowing from other electrical sources does not backflow into that source connection. This may prevent feeding current to electrical lines at undesirable times. In addition, upon power loss, a signal may be sent to the microcontroller 110 which may cause an event to be signaled on the event bus.

In certain embodiments, under normal operation, current from an attached AC source may be connected to an AC synchronizer 114, and possibly, once synchronized and optionally combined with other sources, may be directed to appropriate AC loads via one or more AC load connections 102a-102c. If there are DC loads connected to DC load connections 104a-104c, an AC-to-DC converter in the DC load connections 104a-104c may convert any AC current to DC before passing it along to connected DC load(s).

### IEMS Hardware Architecture-DC Source Connections

The DC source connections 104a-104c may perform similar functions as the AC source connections 102a-102c but may be connected to a DC synchronizer 116 rather than an AC synchronizer 114. The cutoff switch functionality in the DC source connections 104a-104c may disconnect the rest of the IEMS 100 from the DC source if current from the DC source is lost. As with AC source connections 102a-102c, these components may comprise a circuit breaker to ensure current draw is within the appropriate limits.

### IEMS Hardware Architecture-AC Synchronizer

The AC synchronizer 114 may ensure that any AC source is synchronized with respect to frequency, phase, and/or voltage prior to being coupled to the source combiner/redirector 112. In some implementations, no AC sources may initially be allowed to flow to the source combiner/redirector 112, regardless of whether voltage is present.

In some embodiments, under management by a microcontroller within the AC synchronizer 114, one source at a time may be checked, and then pairwise synchronized with another AC source. The combined sources may then be pairwise connected with the next AC source, and this may be done sequentially until each of the AC sources is synchronized with the rest. Finally, when AC sources are synchronized, they may be coupled to the source combiner/redirector 112, which may either (under control of the IEMS microcontroller 110, and in conjunction with the software supervisor) combine or redirect power to appropriate loads.

In certain embodiments, AC sources may not need to be synchronized unless they are combined. The IEMS software may determine whether combination is desired or whether separate AC sources may be connected to distinct loads. A set of software-controlled relays may be used to keep AC sources separate and connected to distinct loads, or whether a combined source is sent to one or more loads. Hardware in the AC synchronizer 114 and source combiner/redirector components 112 may ensure that AC sources are combined when synchronized. Safety interconnect logic may ensure that uncombined AC sources are not connected to each other (through loads or otherwise).

### IEMS Hardware Architecture—DC Synchronizer

The DC synchronizer 116 may operate to match voltage among the DC sources. In some embodiments, the DC synchronizer 116 may ensure that any DC sources that are to be combined are first voltage matched. In some embodiments, the DC synchronizer 116 may also comprise an inverter to convert DC current to AC current. The AC current may be fed to the source combiner/redirector 112, where it can be distributed to loads, either separately or combined. In various implementations, each DC source can be independently inverted and sent to the source combiner/redirector 112 and/or can be combined and sent to that hardware component.

### IEMS Hardware Architecture—Source Combiner/Redirector

In various embodiments, the source combiner/redirector 112 may comprise input ports for the AC and inverted DC sources, as well as ports for combined AC and DC sources. The combined sources can be connected to desired AC loads, as can the individual sources. Logic in the microcontroller 110 paired with software in an IEMS supervisor may determine what sources to connect to which loads and may ensure that any combined sources have been synchronized appropriately before being connected to loads.

In some embodiments, the source combiner/redirector 112 may also have output ports for the AC loads. The job of this component may be to connect sources to loads, under control of the microcontroller 110 and supervisor software. This source combiner/redirector 112 may also sense current at its inputs and outputs and signal the microcontroller 110 upon loss and/or restoration of current.

### IEMS Hardware Architecture—AC Load Connections

In certain embodiments, the AC load connections 102a-102c, which may vary in number based on the model and/or specific configuration of the IEMS 100, may provide a connection to an AC electricity load (e.g. circuit breaker panels, battery chargers). In some embodiments, a fixed number of these connections 102a-102c may be found on a base IEMS device 100, which may be scalable with extension modules being able to provide additional AC connections. The AC load connections 102a-102c may include a circuit breaker to ensure current draw does not exceed capacity.

### IEMS Hardware Architecture—DC Load Connections

An IEMS 100 may comprise one or more DC load connections 104a-104c, which may allow DC loads, such as a DC battery, to be connected. Like AC load connections 102a-102c, these may vary in number based on the model and/or specific configuration of the IEMS 100 and what extension modules may be installed. In some embodiments, the DC load connections may include an AC-to-DC converter, so that if AC sources are directed to be connected to DC loads, the AC current is first converted to DC current. Like AC load connections 102a-102c, the DC load connections 104a-104c may include a circuit breaker to ensure current draw does not exceed capacity.

With DC loads, the IEMS 100 may be capable of routing AC current (from AC source connections 106a-106c) to DC loads (connected to DC load connections 104a-104c). When it does this, the DC load connections 104a-104c may automatically detect the AC current and convert to DC before passing current along to the connected load. The IEMS 100 may also be capable of routing DC current (from DC source connections 108a-108c) to DC loads. In this case, the AC-to-DC converter included in the DC source connections 108a-108c may not be used.

With DC source and load connections 108a-108c, 104a-104c, the IEMS 100 can support scenarios where DC sources, such as solar panels can be connected to DC loads, such as battery chargers, without the loss of power that may result from AC-to-DC converters.

### IEMS Hardware Architecture—Microcontroller

The microcontroller 110 may comprise a general and/or special purpose computer that runs various IEMS software and/or as a microcontroller (which may be a special purpose microcontroller) that communicates with the other hardware components in the IEMS 100. Under control of the supervisor software, it may direct the various hardware and software components and ensures the desired functionality is achieved. Various software components associated with the IEMS 100 are discussed in more detail below.

The microcontroller 110 may be powered by an internal battery of the IEMS 100, which may be kept charged by the various electrical sources coupled to source connections 106a-106c, 108a-108c. In some embodiments, should the battery become depleted, the current sources may continue to remain connected to their connected loads, but changes in configuration may be limited through software. In certain embodiments, hardware source cutoff functionality may not be affected by losing power to the IEMS 100, with current from the sources (or the loss of current) automatically tripping cutoff relays to provide safety disconnects regardless of whether the IEMS 100 has power. In further embodiments, without power to the IEMS 100 (e.g., when the battery is depleted), electrical sources whose power is restored may remain disconnected from any loads.

A manual transfer switch may be included in the IEMS 100 that may allow connecting an AC source corresponding to the electrical grid to a single load (and potentially disconnecting most of the IEMS 100) so that a home and/or business can function until the IEMS battery is recharged. This transfer switch may both connect to the primary load, as well as to a battery charger for the IEMS battery. When the IEMS battery has sufficient charge, a software alert may be sent over the network interface, so that a user can manually actuate the transfer switch for normal operation of the IEMS 100.

### IEMS Hardware Architecture—Radios

The IEMS 100 may comprise various radios 118 (e.g., cellular, Bluetooth, Zigbee, etc.) and their connected antennae. This may allow the IEMS 100 to communicate (under software control) with other systems, services, and/or devices. It will be appreciated that a variety of wireless communication standards and/or technologies may be used to implement various aspects of an IEMS and/or associated communication functionality, and that any suitable standard and/or technology and/or combinations thereof may be used in connection with the disclosed systems and methods.

Demand response commands may be received over the radio 118 (or network) channels, and responses to meter reading commands from the electrical grid may be sent out over RF radios. When signals are received from the hardware radios 118, they may be converted to messages by a software radio interface and sent to the communications interface for handling by the rest of the IEMS 100.

### IEMS Hardware Architecture—Network Interfaces

The IEMS 100 may further comprise network hardware interfaces 120, such as Ethernet and/or WiFi, with their associated wired connections and/or antennae. Similar functions as described for radios may be provided using networking protocols managed by this network interfaces 120. It will be appreciated that a variety of wired and/or wireless communication standards and/or technologies may be used to implement various aspects of an IEMS 100 and/or associated network interface functionality, and that any suitable standard and/or technology and/or combinations thereof may be used in connection with the disclosed systems and methods.

In some embodiments, access to the IEMS 100 over the internet and/or a local area network may be accomplished using the network interface 120. Logic in a software communications interface may determine whether the radio hardware and/or the networking hardware is used for external communications. When traffic is received over the hardware network interface 120, it may be sent to the software networking interface. From there it may proceed to the software communications interface for handling by the rest of the IEMS 100.

### IEMS Software Overview

Various aspects and/or functionality of an IEMS consistent with embodiments disclosed herein may be further implemented using software executed by an IEMS and/or its constituent components. In certain embodiments, the software may comprise one or more functional modules, services, systems, and/or interfaces configured to implement aspects of the disclosed IEMS functionality.

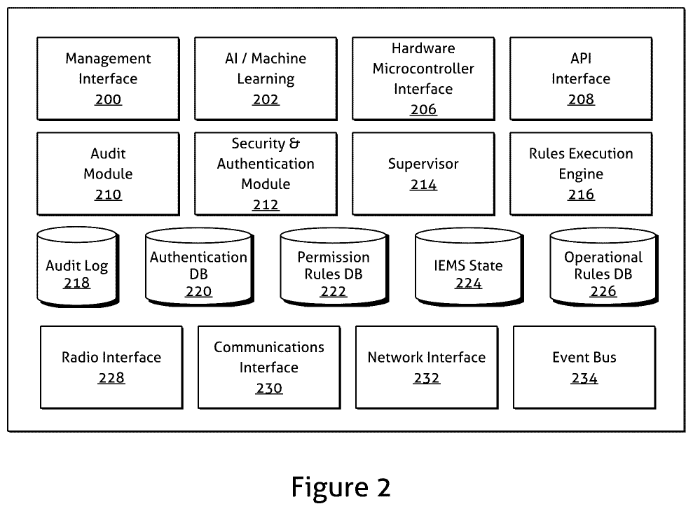

FIG. 2 illustrates a non-limiting example of an IEMS software architecture consistent with certain embodiments disclosed herein. As illustrated, IEMS software may comprise, for example and without limitation, the one or more of a management interface 200, an authentication system for owners and/or stakeholders, a governance system, a rules-based execution engine 216, an API 202 for application integration, and/or a networking stack facilitating communications with the outside world. Various functional modules, services, systems, and/or interfaces of the IEMS software are described in more detail below.

### IEMS Software Architecture—Supervisor

The supervisor 214 may be responsible for implementing certain aspects of the IEMS. In some embodiments, the supervisor 214 may be executed by the hardware microcontroller and may orchestrate functions of the IEMS. In certain embodiments, hardware cutoff of connections to attached electrical sources may be handled in the hardware itself.

In certain embodiments, the supervisor 214 may call upon the functionality of the various software blocks shown in FIG. 2. In certain implementations, upon powering on of the microcontroller, the supervisor 214 may be loaded from EEPROM and initiate a startup sequence, which in some embodiments may start by checking the integrity of the various hardware components. During this phase, the other software components may be started, but may remain largely inactive until the supervisor 214 is ready for normal operation to begin.

During the supervisor 214 startup sequence, a survey may be performed by querying the various hardware components to determine the connected AC and DC sources and the state of AC and DC synchronization. Internal state of the IEMS may be updated by the supervisor 214 in an IEMS state DB 224.

Once the survey and startup of the supervisor 214 is complete, the IEMS state from the IEMS state DB 224 may be queried, and appropriate may be alerts generated to cause the rules execution engine 216 to begin execution based on those signaled alerts. The other software components may be set into operation. Startup operations may be audited by an audit module 210, with corresponding events logged in an audit log 218.

A communications interface 230 may initialize a radio interface 228 and a network interface 232 and the associated hardware components. A management interface 200 may be started and made accessible over the available and configured network interfaces 228, 232. Similarly, an API Interface 218 may be made functional, so that requests coming in over the network interface 232 and/or the radio interface 228 may be directed to the API interface 208 and acted upon.

An AI/machine learning module 202 may be initialized and begin handling any events directed at the module 202. The supervisor 214 may remain running throughout the operation of the IEMS. It may act on events from the hardware and software components, sending some events to the rule execution engine 216 for handling. It may continually monitor the hardware and software components and/or a subset thereof, issuing alerts as required to notify other components and the owner and/or other stakeholders of the IEMS of any interesting events.

The supervisor 214 may maintain objects that can be represented in the IEMS as targets of operations and queries (e.g., from the management interface, API interface, and rules execution engine) in the IEMS state DB 224. In some embodiments, objects may have a set of attributes (e.g., properties) and/or a set of operations that may be performed on them. When an object is queried, these attributes may be returned. When an operation is performed on an object, the supervisor 214 may perform operations. Queries and/or operations may be subject to permission checking. To do so, the supervisor 214 may invoke a security & authentication module 212, which in turn, may leverage a permission rules DB 222 to decide whether the query and/or operation is allowed before performing the query and/or operation.

As mentioned previously, the objects that may be queried or operated on may include the various hardware components, users, the event bus object, external objects, such as the weather, and electricity price information, connected appliances, software components, as well as other synthesized objects. In various embodiments, these objects may define their own set of attributes and/or operations.

Operations on objects (and/or queries to objects) may be invoked from the management interface 200, the API interface 208, and/or the rules execution engine 216. When the supervisor 214 is invoked to query an object or invoke an operation on an object, the success or failure of the query or operation may be sent to the audit module 210, along with details of the query and/or operation. The audit module 210 may then generate an audit record for storage in the audit log 218.

In some embodiments, when the rules execution engine 216 issues disconnect and/or connection requests to the supervisor 214, which in turn, may forward these requests onto the source combiner/redirector, it may not assume that these actions have actually occurred. Rather, the AC and DC source and load connection hardware components may sense the flow of current and can assert that connections are active or not. These hardware components may notify the supervisor 214 of the connection state of sources and/or loads. Thus, when the rules execution engine 214 may query the state of connections, it can be confident that this is the actual situation, rather than basing any decisions on simply having issued commands to connect or disconnect.

The supervisor 214 may monitor the state of hardware and/or software components and the connections between any sources and/or loads. It may update its internal state upon detecting changes. If any anomalies are detected, the IEMS may issue alerts (which can be received and/or acted upon by authorized users and which can be sent as notifications in smartphone applications) but may also ensure the safety of the IEMS and its connections. If anomalous situations are detected, the IEMS may return the connection state to a “safe” one, for example where only the electrical grid is providing electricity to default loads. This may, for example, disconnect other sources of electricity and/or loads.

In some embodiments, the supervisor 214 may also monitor the consequences of operations (e.g., operations invoked by the rule execution engine 216) that indicate that an unstable situation has arisen. For example and without limitation, if rule execution causes a connection to be made between a source and load, and shortly thereafter a disconnection followed by a connection, this could indicate conflicting rules, and/or unstable inputs (e.g., temperature data fluctuating wildly, erratic power outputs, strange charge level changes, etc.), and/or malfunctioning hardware. In these cases, the supervisor 214 may cause the relevant rules to be disabled and an alert sent to notify the IEMS owner (or other authorized parties) of the situation. Operations can be invoked through the management or API interfaces 200, 208 and/or via the rule execution engine 216. This monitoring may also detect unstable operation consequences because of those operation invocations.

### IEMS Software Architecture—Management Interface

The management interface 200 may comprise a web interface, which may be accessible by browser-based interaction (e.g., local network-based browser interaction). In some embodiments, the management interface 200 may be configured to be accessible remotely (e.g., from the Internet or other network interfaces). The management interface 200 may allow authorized parties to manage aspects of the IEMS.

The management interface 200 may allow a user to get the status of the IEMS device as a whole, as well as status of the electrical sources and loads connected to it. Status on sources and/or loads may include, for example and without limitation, information on the type of current (e.g., AC or DC), voltage levels, current levels, power levels, frequency, phase, presence or absence of current, information about whether an electrical source is connected or disconnected from the grid, whether a local electricity source is operating in a surplus and therefore feeding back into the grid, other information of use to the owner and authorized stakeholders and/or the like. Status information may also show what sources may be connected to what loads at any given time.

The management interface 200 may allow existing authorized users to create accounts for other users. These additional users may be granted rights to manipulate the IEMS interface and IEMS rules. For example, an initial owner of the IEMS may wish to grant members of their family and/or company to be allowed to use the IEMS interface, view, and/or modify rules, and/or manipulate sources and/or loads. The management interface 200 may allow the user to view, add, delete, and/or modify IEMS rules, if permissions allow. As discussed in the in more detail below, IEMS rules (which may be managed in an operational rules database 226 and/or a permission rules database 222) may comprise permission rules and/or operation rules. In certain embodiments, to support ease of inspection, the IEMS may permit view-only access permission to devices within a close physical proximity of the IEMS hardware. Such capability may be used to facilitate an inspector and/or an electrician to be able to verify the configuration of the system for compliance with local electrical codes and/or to verify that no hazards are present (or identify potential hazards). In some embodiments, a proximity-based permission system requiring simple authentication over a near field communication (“NFC”) connection may be used for this purpose. In other embodiments, where relatively less security is required, the hardware may be labeled (e.g., indelibly engraved) with a QR code or other identification information that would allow access to a view-only interface of the management interface 200 with which to review the current configuration of the IEMS and/or to view the range of possible configurations that may be available during operation of the system.

In some embodiments, the IEMS management interface 200 may allow any already-signaled alerts to be viewed. These alerts may be signaled by sources and/or loads connected to the IEMS and/or may be signaled by operational rules (e.g., rules managed in the operational rules database 226). These alerts may be acted upon using the IEMS interface, as discussed in more detail below.

The status of individual sources and loads can be queried in the management interface 200, and commands allowed on these sources and loads can be initiated from the interface 200. For example, a user can connect/disconnect loads from sources and/or query the charge level of a battery. In addition, external objects/interfaces allowed in operational rules can be queried as well. For example, the weather, current, past, and/or predicted can be queried (e.g. for temperature, precipitation, wind, etc.). In addition, current, past, and/or predicted future energy costs can be queried from electrical grid providers. This information may be useful when setting up or checking operational rules.

The management interface 200 may be accessible (potentially with otherwise restricted access) to authorized stakeholders, such as the owner, electricity providers (both for transmission and generation), electricity aggregators, and/or other parties. The owner of the IEMS may initially be an authorized user of the interface, but that owner may have the ability to define other stakeholder user accounts and grant them specific permissions to perform queries or control actions of the connected electrical sources and loads. As an example, the owner of an IEMS may create user accounts for family members, employees, and/or external parties, such as grid operators, VPP service providers, remote AI services, etc. The owner may grant permissions to each of these user accounts, to allow and/or restrict what operations these other user accounts are allowed to perform, and/or the like. In some embodiments, one or more local AI agents or modules may be assigned user accounts and an owner may similarly grant permissions associated with such accounts.

Access to the IEMS from the management interface 200 and by authorized users may be authenticated with support for multi-factor authentication. In some embodiments, primary factor authentication may be via username/password or username/key, such as supported by the FIDO2 initiative. Access to the management interface 200 over the local network, and/or external networks, such as the Internet, may leverage Transport Level Security (“TLS”), so that eavesdropping on communications may be mitigated.

In some embodiments, a firewall in the network interface 232 may prevent network access to the management interface 200 except over the local ethernet or WiFi interface initially. However, this firewall may be configured by the management interface 200 so that the management interface 200 may be made accessible from arbitrary hosts on the Internet (if desired).

Users may authenticate with the management interface 200 to access its functionality. On first power up of the IEMS, the management interface 200 may query a user for a username/password, which may be stored in secure storage in an authentication database 220. On subsequent accesses of the management interface 200, these credentials may be provided, unless alternate credentials have been established from a previously authenticated session.

The management interface 200 may support WebAuthn authentication, which may leverage device keys, rather than passwords. Support for these can be established for these in the management interface 200 for user configured user accounts. In some implementations, either password or FIDO2 credentials can be used once WebAuthn has been enabled. Password access can be disabled, and WebAuthn can be used for authentication.

When a user connects to the management interface 200 and subsequently authenticates successfully, the permissions rules DB 222 may be consulted (by way of the security and authentication module 212) to determine the user's rights within the management interface 200. The management interface 200 (and associated specific functions) may be exposed as objects (for the purpose of permission evaluation) and operations that can be performed on these objects can be checked by existing permission rules. Thus, different users of the management interface 200 may be prevented and/or allowed to perform various operations via the management interface 200. For example, a user may be allowed to create other users, or may be denied that ability. Initially, a primordial (e.g., a first) user (e.g., owner of the IEMS) may be allowed full access to the IEMS management interface 200 functions. That first user may create other user accounts, with equal and/or less access.

In some embodiments, the management interface 200 and/or API interfaces 208 may simply invoke operations on objects, as the rules execution engine 216 may allow operations on objects to be invoked. The actual objects and operations on those objects may be defined within the supervisor 214. Functions exposed in the management interface 200 may be exposed as functions over the API interface 208. Objects of these operations may be maintained by the supervisor in the IEMS state DB 224.

The management interface 200 may comprise one or more “views”. These views may comprise one or more of the following non-limiting examples of accessible via menu items:

Overview View. This view may show the overall status of the IEMS. The state of the various hardware and software components may be summarized. Recent events may be displayed. Components and events may be selectable for more detailed status.

Rules Summary View. This view may show all the operational rules, categorized by object category. Rules may be selected for a detailed view of that rule, or deleted, if permissions allow.

Rules Detail View. This view may show the details of the rule, and allows editing, assuming permissions allow.

Permissions Summary View. This view may show the permission rules. Each rule may be selected for a detailed view of that rule, or deleted, if permissions allow.

Permissions Detail View. This view may show the details of a single permissions rule, and allows editing, assuming permissions allow.

User Account Summary View. This view may show user accounts. Each account may be selected for a detailed view of that account, or deleted, if permissions allow.

User Account Detail View. This view may allow viewing and editing of the user account attributes if permissions allow.

Firewall View. This view may show the firewall rules which may govern whether the management and API interfaces 200, 208 are accessible from the outside. The view may allow adding, deleting, or modifying firewall rules, as allowed by permissions.

Event Summary View. This view may show events in reverse chronological order, although other orders are also contemplated. Each event may be selected for a detailed view.

Event Detail View. This view may show the details of a triggered event. The user can determine which component/object triggered the event, and event parameters/attributes provided. Since events are associated with a user account (which may include a “system” account for system-generated events), that account may also be shown. If the event signaling triggered an operational rule execution, that may be shown as well.

Audit Summary View. This view may show the audit log 208-a set of records that reflect operations performed on which objects and by what user account (or the “system” account if system-generated). Audit log entries may be selected for a detailed view. In some embodiments, if audit records are flagged as being intended to be sent to some external recipient (such as a VPP or electrical provider), they may not be deleted from the IEMS unless they have been sent to that external entity and acknowledged by that entity as having been received.

Audit Detail View. This view may show the contents of an audit record of the audit log.

AI/Machine Learning View. This view may show determinations made by the AI/machine learning module 202, and/or any associated recommendations for operational rules. These recommendations may be acted upon using the UI and added to the operational rules DB 226, possibly preceded with edits by the user. It also may show the operations performed because of operational rules that resulted from AI/machine learning module 202 operations. Recommendations from the AI/machine learning module 202 may be informational and not tied to recommended operational rules. For example, notices about upcoming weather and/or electricity prices may be provided by the AI/machine learning module 202, with or without explicit recommendations for new or changed operational rules.

Networking View. This view may allow configuration of the wired or wireless network. This view may be similar to networking view interfaces provided in wired and/or WiFi routers.

Startup/Wizard View. This view may be shown the first time the management interface 200 is started and provides the user with a guided setup of the IEMS. When the IEMS is first installed or when it is factory reset, this view may be shown. After the IEMS does a survey of the attached sources and loads, the user may be presented with recommendations regarding operational rules to provide a good, default operation of the IEMS. The startup/wizard view may have modes for more technical users, but otherwise may assume the user just wants “the right choices” made for them automatically.

Configuration/Layout View. This view may show the current configuration of sources and loads, whether they are AC or DC, how they are connected (if connected), and/or the like. It also may show detected appliances/devices and how they are connected to sources and loads.

### IEMS Software Architecture—Setup and Configuration

While the IEMS supports sophisticated, rule-based operation, it may also be used by customers who don't wish to learn how to configure and define rules. In some implementations, upon initial installation of an IEMS in customer premises, the IEMS can function with little to no setup. In some embodiments, by default, it may act as a smart meter, connecting the electrical grid to attached circuit breaker panels. If other sources of electricity (e.g., solar panels, batteries, wind turbines) are connected to the IEMS, the intelligent software may keep batteries charged and leverage electrical sources to power the connected loads.

If the management interface 200 is accessed (by the presumed new owner of the IEMS), the interface 200 may invoke a wizard to help the user customize the functions of the IEMS. The wizard may lead the user through various configuration options and automatically generate the appropriate permission rules and operational rules. The wizard can be abandoned at any time, leaving the user to manually configure the IEMS, or not, as desired.

The default configuration may keep batteries charged to some default level, occasionally discharging the batteries through the connected loads to ensure improved efficiency of the batteries. Connected EV chargers may keep EVs charged at default levels unless customizations dictate different behavior. In some implementations, customer electricity sources may feed into the electrical grid by default.

A default configuration may send alerts, but in some implementations these alerts may be ignored because the default rules may ensure that correct and safe operation of the IEMS will be assured. However, if the user connects to the management interface 200, they may see current and past alerts, and can act on them if desired. Connected smartphones may receive these alerts as notifications, which can be disabled, if desired (mobile phone alerts may be enabled by the user on installation of a mobile IEMS application). These notifications may include alerts of weather events or electricity cost changes, for example and without limitation.

As a component of the electrical distribution system, safety may be a concern for IEMS installations. It The IEMS may therefore be properly configured with sources and loads are connected in ways that will not exceed the rated capacity of associated electrical wiring (e.g., conductors, distribution panels, outlets, etc.) used to connect them. In some embodiments, permissions to set up or edit certain configurable objects relating to the attributes of connected sources and loads may be restricted to authorized personnel only (e.g., licensed electricians, manufacturer-certified technicians, etc.).

As a non-limiting example, an electrician servicing a premises may observe that an EV charger is being connected to the IEMS via a 50 AMP rated NEMA 14-50 outlet and a conductor rated for 50 AMP. Recognizing that the conduit-run conductor should have a safety factor applied, the electrician may set attributes within the IEMS that rates the maximum capacity for this connection at a reduced level of only 40 AMPS. The IEMS may then apply this limitation when evaluating rules and connecting sources with loads. In certain embodiments, the IEMS may require additional authentication credentials to edit attribute information, configuration information, and/or rules. For example, a licensed electrician may need to authenticate with a remote service that maintains records of current status of licensed electricians (using for example and without limitation an OAuth protocol) to provide the necessary credentials to the IEMS system to edit such information. The IEMS may also record an audit record when such configurations, attributes or rules are modified, the audit record may comprise information associated with who performed the edit, a license or certification number, time of change, date of change, permit number (if applicable), information edited, and/or reason, etc.

### IEMS Software Architecture—Rules Execution Engine

The rules execution engine 216 may provide a rich, customizable environment for connection sources and loads, charging batteries (including EVs), integrating with intelligent devices connected as loads, and generally doing the right thing to optimize the usage and costs of electricity. The rules execution engine 216 may leverage a database of operational rules 226 and cause the execution of consequences of any applicable rules when certain events are triggered or signaled.

The rules execution engine 216 may monitor for signaled events and may scan the operational rules in the operational rules DB 226 to see if any of the rules have their conditions met. For example and without limitation, a condition may be the presence of an alert (e.g., signaled by the IEMS, a device, or external conditions). When the condition is satisfied, the operation specified within a rule may be invoked on the referenced object, with the specified parameters. This may be done if the specified subject has permission to invoke the specified operation on the object, as determined by permission rules, described in more detail below.

In some embodiments rule execution may be chained, by having the operation of one rule signal an event, which matches a condition of another rule. Thus, more complex workflows may be configured such as embodied in the following non-limiting illustrative scenario: “When the charge level of an EV battery exceeds a specific threshold, the solar panels charging that battery may be disconnected from the battery and connected to the charger of a battery storage system. When the battery storage system becomes fully charged, the solar panels may be directed to feed back into the electricity grid.”

Because there may be a time lag between the time that commands to connect or disconnect sources and loads actually take effect, and to mitigate the possibility that one of these commands failed in execution, chained rules may rely on signaling events and checks of connection state based on information gathered by the source combiner/redirector and the actual AC and/or DC source and/or load connection components. These components may notify the supervisor 214 of changes to connections for any of the sources and/or loads.

The supervisor 214 may update its state in the IEMS state DB 224 to reflect this state. Rules may be constructed such that connections are not made until the connection state of any referenced sources and/or loads is verified (e.g., verified via hardware). If a user or program tries to create a rule that, for example, disconnects a source from a load, and then connects it to another load, the rule may be rejected. The rules editing feature of the management interface may suggest that a subsequent rule be created and provides a template for ensuring that the disconnect request has actually been effective before the connect request is issued.

### IEMS Software Architecture—Operational Rules

Operational rules, which may be stored and/or otherwise managed in an operational rules database 226, may define the behavior of the IEMS with respect to controlling electrical sources and loads, the interconnection among them, and/or the use of one or more electrical sources to run one or more loads. Because the IEMS may be connected to the Internet, it may have access to weather prediction information and up-to-the-minute electrical grid electricity charges. In some embodiments, because the IEMS may be software-extensible via a Software Developer Kit (“SDK”), it may leverage external services provided by third parties in the evaluation and execution of operational rules.

In some embodiments, operational rules may be established that customize the routing of electrical sources and/or loads based on the current or predicted weather and electricity charges, within some limits parameterized by those operational rules. A relatively simple non-limiting example of this might be an operational rule that dictates that connected solar panels may be used to charge EV batteries, unless the grid electricity costs rise above some configured level, in which case they may be used to feed back into the electrical grid.

In certain embodiments, operational rules may include expressions that reference the electrical sources, the distinct electrical loads, the user accounts, attributes of electrical sources (such as voltage, current, etc.), attributes of electrical loads (current draw, power consumption, etc.), external sources of information (such as electricity prices, grid providers, electricity costs, weather information-current, past, and/or predicted), the current date/time, and/or the like. The set of objects and attributes that can be referenced by the operational rules may be extensible, via software updates, or user defined attributes.

In further embodiments, operational rules may also reference named, addressable appliances connected to the loads that are connected to the IEMS. For example, a refrigerator, dryer, smart thermostat, and/or EV charger may be referenced in operational rules.

Operational rules may specify actions to be performed, including, for example and without limitation, the connection of one electrical source (e.g., the grid, batteries, solar panels, wind turbines) to one or more electrical loads (e.g. circuit breaker panels, batteries, EV chargers, etc.). Similarly, the disconnection of a source from a load may comprise an expressible action.

In addition, actions may specify operations that individual named appliances may support. These may include, for example and without limitation, the changing of the temperature settings in a thermostat, freezer, and/or refrigerator, the speed of a fan, the charge level or duration of an EV charger, and/or the like.

Operational rules may be conditionally executed based on events that may trigger them. Events may be signaled by the connected sources and/or loads. They may also be signaled by external services, as in changes to the weather or electricity costs. Alerts may also be signaled by the AI/machine learning module 202 of the IEMS. Alerts may be further signaled directly in operational rules. Thus, operational rules may be triggered by events and may signal events. In some embodiments, chains of operational rules may be executed when conditions warrant.

In certain embodiments, operational rules may be represented as a tuple of: [subject, condition, object, operation, and operation parameters], although other suitable structures for defining operational rules may also be used.

A subject may identify which user account is used to perform any operation defined by the rule. The user account may have been previously defined via the IEMS management interface or via an “create-account” API call. The user account may also have been granted permissions to perform the referenced operation on the referenced object. An operational rule specifying a subject without permissions to perform the specified operation may result in a security alert, which may be viewed in the management interface, the security logs, and/or used to trigger additional operational rule execution.

An object specified in an operational rule may represent any of the addressable objects defined by the IEMS. In addition to the sources and/or loads, external objects such as weather, electricity price reporting services, and/or the like may also act as objects. In some embodiments, a special “eventbus” object may be supported as well. This operation may support a “signal-event” operation, so that an operational rule may signal an event or alert. Specifically, an operational rule may trigger an event by specifying the “signal-event” operation and the “eventbus” object. The operation parameters may include the name of the event to be signaled.

The condition field of operational rules may query some attribute of an object and/or some external source of information. For example and without limitation, a condition might be “when the temperature of the living-room-thermostat is >70 degrees fahrenheit”. As another non-limiting example, a condition could be “when the weather temperature is >20 degrees Celsius” or “when the weather indicates that it is raining”.

As a specific non-limiting example, there can be an operational rule that specifies the condition, “when the outside temperature (as specified by the current weather) is greater than 60 degrees fahrenheit AND solar-panel-1 is generating over 6 Kw of power.” The subject may be the owner of the IEMS. The object may be the circuit-breaker-panel-1, and the operation may be “change-source-to” with a parameter of solar-panel-1. This example rule may have the effect of switching the power source of circuit-breaker-panel-1 to solar-panel-1, when the conditions specified in the operational rule are met.

Because operational rules may specify the signaling of an event on the eventbus, and other operational rules may specify a condition such as “when eventbus-event event-1 is signaled”, it is possible for the execution of one operational rule to trigger the execution of another, in so-called operational rule chaining.

In some embodiments, the IEMS may support the mapping of demand and/or response events from existing grid services (e.g., OpenADR) to IEMS events. Thus, a demand/response event from the grid may trigger the execution of one or more operational rules.

The IEMS may detect the presence or absence of electricity coming from the electrical grid. When a power failure is detected, an event may be generated, which may trigger operational rules to switch loads to other electricity sources. When power is restored, another event may be signaled, which may trigger operational rules that may reconnect the electrical grid source to configured loads. In some embodiments, operational rules may not violate the safety restrictions enforced by the IEMS, such as connecting other sources to the electrical grid source during a power outage.

As mentioned previously, events can trigger operational rule execution, which can, in turn, trigger other events. As a result, a chain of actions can be orchestrated through proper configuration of related operational rules. For example, use cases such as the following non-limiting example can be implemented using this scheme: Assume you have two different batteries that can be charged, for example, an EV battery and a battery storage system. You configure the IEMS box to connect the solar panels to the EV charger to charge the EV battery. When the battery is charged to some desired percentage, an event is triggered and another rule fires, which disconnects the solar panels from the EV charger, and connects them to the battery storage system. When the battery storage system is fully charged, another event causes the solar panels to be disconnected from the battery storage system, and the energy fed back into the electrical grid. This example leverages three operational rules, with events triggered from one rule causing another rule to execute.

In some implementations, the notion of “fully charged” for a battery may be user definable. For example, a battery may be considered “fully charged” when it reaches a charge level of 80%. Thus, the “done-charging” event may be triggered when the battery reaches any desired level of charging.

### IEMS Software Architecture—Security and Authentication Module

This security and authorization/authentication module 212 may oversee maintaining a high level of security surrounding the operation of the IEMS device. The rules execution engine 216 may query the security and authentication module 212 to determine whether the subject specified in an operational rule is allowed to perform the rule's operation on the rule's object. The security and authentication module 212 may consult permission rules to determine the rights that a given subject has been granted. It may invoke the audit module to audit the success or failure of any attempted operation on an object.

The security and authentication module 212 may also manage the firewalls used by the communications interface 230, network interface 232, and/or radio interface 228. In addition, this component is used to authenticate users in the management interface 200 and API interface 208.

As described above, users of the IEMS may have associated accounts, and those accounts may have been granted permissions, in the form of permission rules, to perform operations on objects. In some embodiments, to be able to access the IEMS, a user may log in with a username and either password or FIDO2 credential, although other authentication paradigms may also be used. A second factor may also be required, which may be configured by the primordial user and/or any other user authorized to specify this requirement. A user may also enable second factor authentication if desired.

API access to the IEMS may also be managed via user login processes, such as when external (authorized) users wish to invoke APIs of the IEMS. For example, an API user may first authenticate to the IEMS and receive an access token which may be used in connection with various exposed APIs. The security and authentication module 212 may validate authentication information and access tokens.

### IEMS Software Architecture—Permission Rules

Consistent with embodiments disclosed herein, permission rules, which may be storage and/or otherwise managed in a permission rules database 222, may authorize, deny, and/or limit access to user accounts defined in the IEMS to view status and/or initiate commands. For example and without limitation, a business owner of an IEMS may wish to grant some employees, who also have accounts in the IEMS, the ability to control some sources and loads or appliances at a granular, action-specific, level. Or the IEMS owner may wish to allow the electrical grid operator to adjust the thermostat or freezer temperatures when electricity demand is high. Permission rules may also limit these kinds of adjustments (e.g., actions). For example and without limitation, the electrical grid operator may be allowed to adjust an air conditioner temperature upward, but not to exceed 26 degrees Celsius (i.e., 78.8 degrees fahrenheit).

In certain embodiments, permission-based rules may be defined as being a tuple of: [subject, operation, object, allowed/disallowed flag, limits]

For example and without limitation, a permission-based rule may state that subject=“Helen” is allowed to perform the operation “temperature-change” on the object=“living-room-thermostat” with no limits. Or limits can be specified such as “temperature<=72 degrees fahrenheit AND temperature>65 degrees fahrenheit”.

Another non-limiting illustrative example might specify that subject=“George” is allowed to perform the operation=“move-load” on the object=“circuit-breaker-panel-2” with the limit “electricity-source member-of (solar-panel-1, battery-storage-1)”. This permission rule may limit the ability of George to move the “circuit-breaker-panel-2” load to only the “solar-panel-1” and “battery-storage-1” sources. As a result, unless another permission rule grants more access, George may not be able to connect the electrical grid (e.g. a source called “electrical-grid”) to “circuit-breaker-panel-2”.

Subjects in permission-based rules may correspond to defined accounts, which may include external parties, such as grid operators or grid aggregators, other businesses, and/or family members. Objects in these rules may correspond to any of the electricity sources and electrical loads connected to the IEMS, as well as any of the configured appliances connected indirectly to those loads. The allowed/disallowed flag may designate whether the permission grants or denies the mentioned operation to the specified subject. The operation may be a string that presents any of the specific operations allowed on the corresponding object. Each object may allow a predetermined set of operations on that object. Finally, the limits field of the rule may be an expression referencing parameters that are applicable to the objects and/or operations. These may be general, or specific to a given operation on an object. The intent of the limits is to provide the bounds of parameters to operations on objects.

In some embodiments, a special object may represent the “permission-rules”, to allow granting or denying access to user accounts to add, delete, and/or modify other permission rules. Similarly, a special object may represent the “operational rules” to provide the same control over the operational rules.

In various embodiments, operations that may be performed by the IEMS may be allowed or denied, or allowed within limits, for a given user account. Stakeholders in the electricity utilization ecosystem, who may have an interest in the control of the IEMS, may be registered with a named, authenticated, user account in the IEMS (using the management interface 200). In some embodiments, the IEMS may allow a given stakeholder (e.g., user account) to access the IEMS after authentication, and if commands or queries from the stakeholder are sent over encrypted, communication channels.

In some embodiments, the security and authorization module 212 may also check devices/appliances connected to the IEMS loads for security properties. It may query devices to determine their type and then consult a trusted ledger to obtain a trusted description of the device capabilities, limitations, operations, and attributes supported, firmware status, certification status of firmware, etc. Because the IEMS may analyze devices connected to the IEMS loads to detect new devices, removed devices, and/or changes in the software/firmware of devices, it may leverage the trusted ledger to ensure that the device is running uncompromised or approved firmware, and warn the IEMS administrator through alerts when compromised or unapproved firmware or devices are detected. When firmware updates are available for connected devices, and that firmware has not yet been updated on the device, it can send alerts to the IEMS administrator suggesting to them that the device's firmware be updated.

The security and authentication module 212 may also ensure that trusted services are used for information retrieval (such as weather information and electricity price information) by ensuring that the URLs used appear in trusted ledgers, and that keys used for encryption and signatures when using those services are trusted. This may mitigate threats introduced by bad actors where “bad data” is returned, which may cause operational rules to execute under false conditions. For example and without limitations, if there are operational rules where conditions check the current or anticipated prices of electricity, or the current or forecast weather, a bad actor might return information in price queries such as “the price is spiking in an hour”, or in weather queries such as “it will be 140 degrees fahrenheit tomorrow” and this might cause improper and unintended execution of operational rules. In certain embodiments, the integrity of such external data may be assured by the security and authorization module 212 by leveraging trusted ledgers.

### IEMS Software Architecture—Authentication

In some embodiments, registered users of the IEMS may authenticate over the web (e.g., via the management interface 200) or API interfaces 208 prior to being able to access any status information or perform any operations. In some embodiments, standard OAuth2 authentication, including support for multi-factor-authentication may be supported by the IEMS. In addition to password-based credentials, IEMS may support FIDO2, key-based credentials.

In certain embodiments, for API use, token-based authentication using credentials separate from that of the web management interface 200 may be employed. These credentials may be presented over secure channels, and an authentication token returned, that in turn, may be provided with any API calls to authenticate the caller.

### IEMS Software Architecture—Communications Interface

The communications interface 230 may comprise a software component that manages communications via the network and via the radios to the world outside the IEMS. In various embodiments, specific network and radio communications may be handled by the network interface 232 and radio interface 228, respectively, but the communications interface 230 may provide a general interface to the IEMS, so that it may send messages and receive messages regardless of the communications medium.

### IEMS Software Architecture—Network Interface

The network interface 232 may manage the WiFi and Ethernet hardware interfaces of the IEMS. It may provide IP address management functionality, the network firewall (with help from the security and authentication module), and IP/TCP/UDP and other network protocols over these interfaces. In some embodiments, the API interface may leverage the network interface 232 to perform the low-level communications over the network.

### IEMS Software Architecture—Radio Interface

The radio interface 228 may manage the hardware radios (e.g., Bluetooth, ZigBee, etc.) in the IEMS. It may forward messages received from these hardware radios to the communications Interface and accept messages from the communications interface to be sent using the radios.

### IEMS Software Architecture—Audit Module

In various embodiments, the audit module 210 may have the responsibility of securely maintaining an audit log 218 of operations performed on and/or by the IEMS, including those invoked through external actors over the API Interface, and responses to DR commands. When the rules execution engine 216 invokes the supervisor 214 to perform an action on an object, the audit module 210 may log the success or failure of the request, along with details of the request in the audit log 218. A subject of the audit log 218 records may be flagged (through configuration in the management interface) as needing to be delivered to an external entity (e.g., such as a VPP). These records may, for example and without limitation, show how the IEMS responded to a demand/response command from an external party (e.g. VPP).

The audit module 210 may leverage the communications interface 230 to form messages to be sent over the network interface 232 and/or the radio interface 228 to stakeholders outside the IEMS. In some embodiments, the audit log 218 may be protected from tampering except by authorized user accounts. In certain implementations, the audit log 218 may be considered an append-only, integrity-protected log. Old audit records in the audit log 218 may be purged after set time intervals, accumulated size limits, and/or whether the audit record has been delivered to any required external stakeholders.

The audit log 218 may allow the owner of the IEMS, and other authorized users to, for example and without limitation, determine precisely what operations were performed, why they were performed, the time and date of the operation, and/or user account that initiated the action. DR commands and any actions performed by the IEMS may also be logged in the audit log 218. A configured subset of these can be delivered to an external party (e.g., the electrical grid operator or aggregator) to acknowledge the handling of a given DR command.

Trusted audit records may be securely signed by the IEMS using a private key that is securely stored within the IEMS. This may allow parties that rely and/or otherwise use the audit records to verify the authenticity of the records using associated public keys published by trusted parties (such as device manufacturers, certification bodies, etc.) in databases and/or or publicly accessible trusted distributed ledgers. Trusted audit records may be generated by the IEMS based on data securely received from connected components and/or may incorporate data objects that themselves are signed by attached trusted charging system components and/or trusted, tamper-protected battery monitoring circuitry incorporated into the battery subsystem itself.

### IEMS Software Architecture—Event Bus

The event bus 234 may allow IEMS components to signal events and generate alerts. Any component that signals an event causes an event record to be maintained by the event bus 234. Event records may be time stamped and include expiration times, as well as information as to the source of the event (e.g., which IEMS object signaled the event). The event bus 234 may record information about which objects are interested in receiving alerts when events are signaled. The event bus 234 may generate alerts based on events and sends those alerts to IEMS components that have registered an interest in receiving them. The rules execution engine 216 may, for example and without limitation, express interest in receiving alerts when any of the active operational rules includes a clause in the rule condition field that references the event/alert. As mentioned previously, the operation in an operational rule may also trigger/signal an event. Thus, the rules execution engine 216 is both a consumer and generator of these events.

The management interface 200 may also have a configured set of events that it listens for and displays in its UI. This may also be true for the communications interface 230, which may send alerts to authorized mobile phones or external services based on events it receives from the event bus 234.

### IEMS Software Architecture—API Interface

In addition to the web-based management interface, the IEMS may support an HTTP-based API interface 208. Functionality available over the management web interface 200 may also be available through the API interface 208. The API interface 208 may allow programs on external devices (e.g., computers, smart phones, web services) to invoke functionality of the IEMS. In some embodiments, API access may be initially disabled but can be enabled by an administrator using the web interface. API access may be limited to the local area network, to specific ranges of IP addresses, and/or completely open.

The API interface 208 may allow for invoking functionality of the IEMS (e.g., operations and queries) from outside the IEMS hardware via APIs. These APIs may be invoked over HTTP using REST, or in some embodiments, using different network/packet protocols, and different encoding techniques. External connections to the network interface 232 and radio interface 228 may be authenticated (with an access token) and messages in both directions may be encrypted and signed. APIs that query attributes from IEMS objects may require that the authenticated user of the API has the appropriate access to query the attribute on the object, by leveraging the security and authentication module 212 to check permission rules. Similarly, an API that invokes an operation on an object may also be authorized by the security and authentication module 212.

The architecture of the API interface 208 may be general and allow (subject to permission checking) the query of attributes on objects and the invocation of any operation on those objects. In some embodiments, the API interface 208 may be disabled by default and may be enabled by an authorized user in the management interface 200. The API interface 208 may also be protected by a firewall in the network interface, which can limit from what endpoints an API request may originate.

As detailed above, API calls may be authenticated. In some embodiments, this may be accomplished by requiring an access token, acquired using OAuth2 or similar means, to be passed into each request. The security and authentication module 212 may both generate and manage these access tokens and may check these access tokens during an API call. In various embodiments, API invocations, whether successful or unsuccessful, may be audited by the audit module 210.

### IEMS Software Architecture—AI/Machine Learning

The AI/machine learning module 202 may be an optional component of the IEMS, which in some embodiments may be downloaded and installed into the IEMS. This may allow the functionality of this module to be sold and/or other installed separately. The functionality of the AI/machine learning module 202 may be open-ended, but may include AI software to analyze usage, trends, costs, weather, etc. to build up some understanding of the environment in which the IEMS may be running. The AI/machine learning module 202 may suggest additional operational rules based on its analysis, which may be presented to the IEMS administrator through the management interface 200 and/or alerts sent to authorized mobile devices.

The AI/machine learning module 202 may use predictive analytics, possibly leveraging external services for information retrieval, to suggest operational rules which may be of benefit to the IEMS administrator. For example, if weather predictions suggest that wind may increase in the next week, and the IEMS has connected wind turbines for electricity generation, it may suggest to the IEMS administrator a change in the operational rules to take advantage of that wind in advance of its coming (e.g. as a non-limiting example, to allow batteries to maintain a lower level of charge in preparation to have storage capacity available for renewable energy). Similarly, anticipated electricity cost increases may suggest fully charging batteries from the electrical grid, so that they may be used when electricity costs increase in the future.

As operational rules are manually approved or possibly automatically added, the operation, efficiency, and costs related to electricity usage may change, and the AI/machine learning module may analyze these changes to ensure the current set of operational rules are optimal. In some embodiments, to reduce the local computing requirements of the IEMS and the costs to provide those requirements, the AI/machine learning module 202 may be implemented as a cloud service, with audit logs 218 from the IEMS uploaded to the service, and recommendations for changes in the configuration and/or operation rules returned by the service to the IEMS.

### IEMS Software Architecture—Hardware Microcontroller Interface

In various embodiments, the hardware microcontroller interface 206 may retrieve status and take actions based on the various hardware microcontrollers present in the IEMS device. There may comprise microcontrollers in the AC synchronizers and combiners, as well as in the DC combiners, that ensure the proper and safe operation of those functions. The hardware microcontroller interface 206 may monitor these microcontrollers to ensure they are functioning correctly and alert the IEMS administrator (and cause the execution of any operational rules whose conditions are dependent on these alerts).

The hardware microcontroller interface 206 may also survey the connected devices (e.g., sources, loads, devices, appliances) and notify the IEMS supervisor of newly connected or disconnected devices. This may allow the supervisor to update IEMS state and perform security checks on connected devices and appliances.

### Safety Features

The IEMS may be connected to the electrical grid. When the IEMS detects a power failure—that is, the absence of electricity coming from the grid source—it may function as a transfer switch disconnecting the IEMS, electrically, from the grid. In some embodiments, this transfer switch function may not be controlled by operational rules, or the user accounts defined in the IEMS, but rather may be a security feature built into the box. This may prevent electrical energy produced by any of the other sources connected to the IEMS (e.g., solar panels, wind turbines, batteries, etc.) from feeding back into the electricity transmission lines, and possibly providing a hazardous situation for electrical grid employees working on the transmission lines. When power is restored from the electrical grid, the IEMS may detect this, and can electrically reconnect the source to any of the loads that have been configured.

### Communications/Networking Stack

Some embodiments of the IEMS may support a web-based management interface 200 as well as an HTTP-based API interface 208. As such, these embodiments may use a TCP/IP based networking stack. The IEMS may also support communications to local and nearby devices via Bluetooth. In situations where ready access to the Internet is not possible (and/or to supplement such access), embodiments of the IEMS may include a cellular-based interface and/or radio-based interface, such as Zigbee. These mechanisms may allow the IEMS to communicate with external devices and networks in situations where ethernet or WiFi are not available and/or less reliable.

Integration with Smart Appliances

Many home and business appliances can integrate with home or business automation (e.g., Matter, HomeKit, Google Home, etc.). In some embodiments, the IEMS device can similarly integrate with these automation standards and can detect the presence of smart connected devices. For example, the IEMS can detect a smart refrigerator and/or smart thermostat and may optionally be configured to be able to issue commands to and query status from these appliances. Through its operational rules managed in the operational rules database 226, the IEMS may be configured to control these appliances—for example, in times of high energy demand, adjusting the refrigerator or air conditioner thermostat to ease demand on the grid.

In some embodiments, if any connected appliances support issuing alerts and/or commands, they can be used to trigger the execution of defined operational rules. Because IEMS may integrate with home automation standards, applications provided for smart phones and computers to control home or business automation can also send commands and trigger events to the IEMS, which, in turn, can trigger the execution of operational rules.

### Example Use Case and IEMS Operation—Grid, Solar Panels, and EV Connections

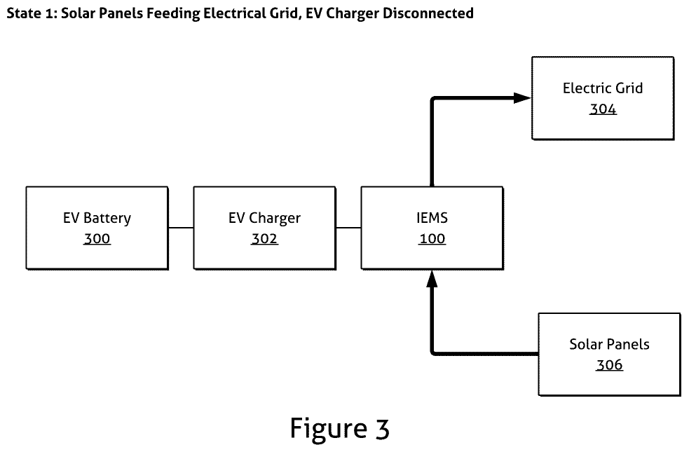

In at least one non-limiting illustrative example, an IEMS may be connected to solar panels and electrical grid sources. FIG. 3 illustrates a non-limiting example of an initial state of a system implementing an IEMS 100 in an example operational scenario consistent with certain embodiments disclosed herein. As illustrated, an EV charger 302 may be connected to an IEMS 100a as a load, and an EV may plug into the EV charger 302 so that the EV battery 300 may be charged. The IEMS 100 may be further connected to a solar panel system 306 and/or the utility electric grid 304.

In the illustrated initial state, power generated by solar panel system 306 may fed to the electric grid 304 by the IEMS 100. In this manner, no sources (e.g., grid 304, solar panel system 306) may be currently connected to the EV charger 302, and no local loads may be currently connected to the solar panels 306. The solar panels 306, however, may feed generated electricity to the electrical grid 304 to reduce the IEMS user's costs.

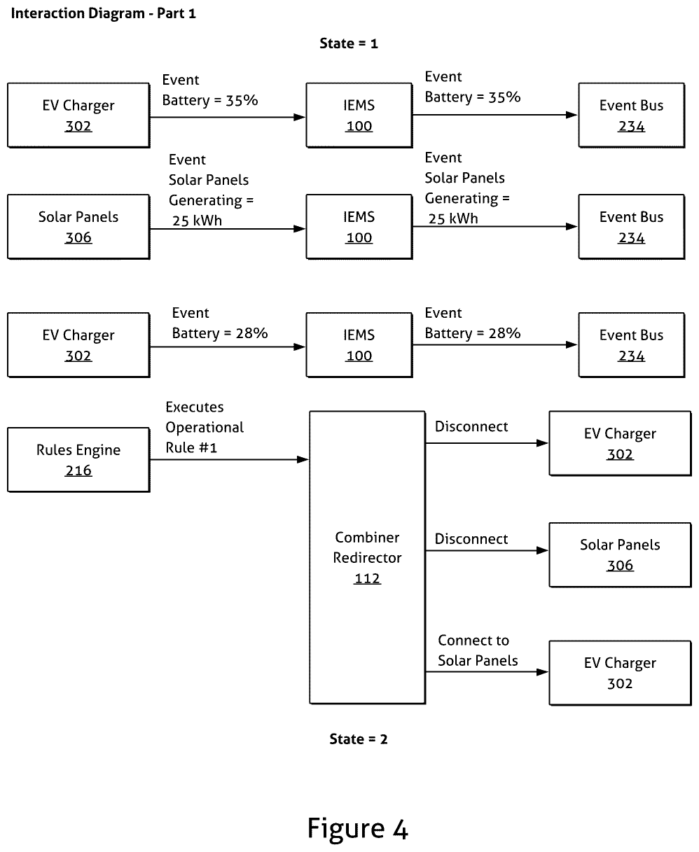

FIG. 4 illustrates a conceptual diagram of a non-limiting example a sequence of operations of an IEMS 100 in the example operational scenario consistent with certain embodiments disclosed herein. In the example scenario, the EV battery may initially be at 35% and the solar panels 306 may be generating 25 KW of electricity. The following example operational rules may have been established:
Operational Rule #1—condition: “when EV battery charge is <30% & solar panels generating>30 kW power”|operation: connect solar panels to EV charger (exclusively).
Operational Rule #2—condition “when EV battery charge is >=80%”|operation: disconnect source from EV battery.
Operational Rule #3—condition: “when solar panels are disconnected from loads”|operation: feed solar panels power to electrical grid.

Non-limiting examples of a sequence actions taken by the IEMS 100 based on these example operational rules may comprise:
IEMS 100 detects or is notified that EV battery is at 35% charge.
IEMS 100 signals event “battery charge=35% from EV battery object; event is stored in event bus 234, and rules 216 engine is notified.
Rules engine 216 takes no action after consulting operational rules.
IEMS 100 detects that solar panels are currently generating 25 KW electricity.
IEMS 100 signals event “power output=25 kW” from solar panels object; event is stored in event bus 234, and rules engine 216 is notified.
Rules engine 216 takes no action after consulting operational rules.
IEMS state reflects that EV charger 302 is not connected to any sources and that solar panels 306 are connected to the grid.
IEMS 100 makes no changes at this point.
The EV driver may take the EV to go to work and return it with 28% charge before plugging it into the EV charger 302.
IEMS 100 detects that EV battery charge is 28% and signals event “battery charge=28% from EV battery object” on the event bus 234
Rules engine 216 is notified of event, but no rules are executed, and IEMS makes no changes.
Solar panels begin producing 35 kW electricity.
IEMS detects that solar panels are generating 35 kW electricity and signals event “power output=35 kWh” from solar panels object.
Rules engine 216 is notified.
Rules engine 216 evaluates Operational Rule #1 defined above
Source combiner/redirector 112 is notified to disconnect other sources from EV battery charger 302, disconnect solar panels 306 from grid, and to connect solar panels 306 to EV battery charger 302.

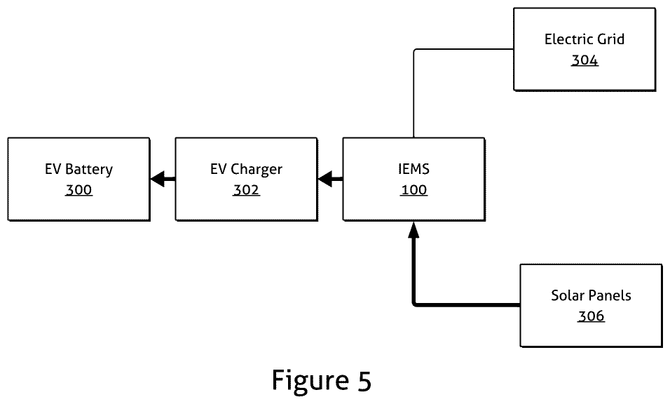

FIG. 5 illustrates a non-limiting example of a state of a system implementing the IEMS 100 with the solar panels 306 feeding the EV charger 302 following the state transition caused by the execution of Operational Rule #1 as detailed above consistent with certain embodiments disclosed herein. As shown, the solar panels 306 may provide power to the EV charger 302 via the IEMS 100 to charge the EV battery 300.

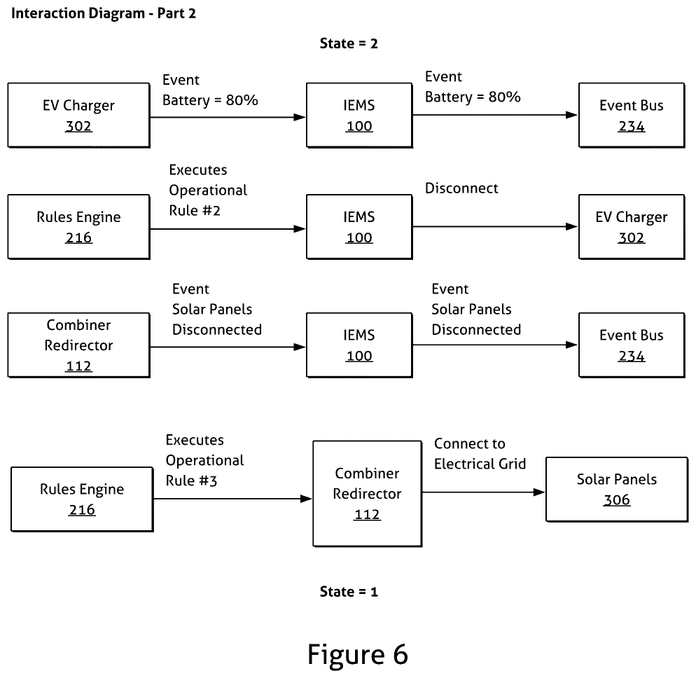

FIG. 6 illustrates a conceptual diagram of a non-limiting example a sequence of operations of the IEMS to transition back to the initial state in the example operational scenario consistent with certain embodiments disclosed herein. Using the above detailed operational rules, the IEMS 100 may perform the following actions:
EV battery charging by EV charger 302 charges to 80% reported to IEMS 100 and stored in event bus 234 and signaled to rules engine 216.
Rules engine 216 notices event “EV battery charge is =80” and triggers Operational Rule #2.
Source combiner/redirector 112 is notified to disconnect solar panels 306 from EV charger 302.
Upon disconnect, the source combiner/redirector 112 signals event “solar panels disconnected from all loads to the IEMS 100 which may report the event on the event bus 234 . . . .
Rules engine 216 may be notified of the event.
Rules engine 216 executes Operational Rule #3 and directs combiner/redirector 112 to connect the solar panels 306 to the electrical grid.

### Multiple Stakeholders and External Entities

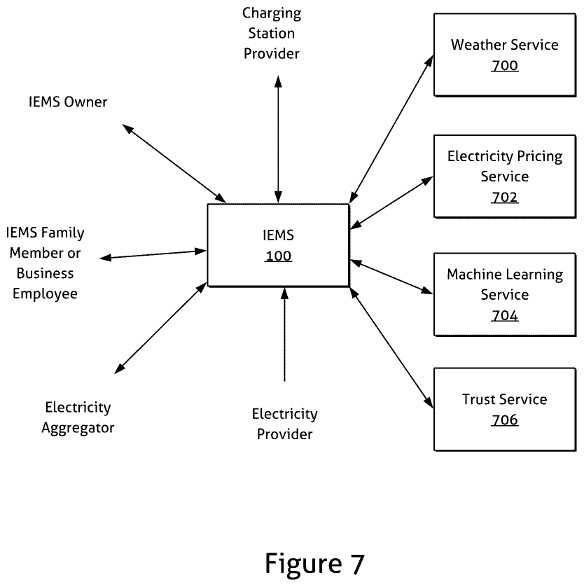

A variety of users may interact with the IEMS, including stakeholders such as an owner, family members, business employees, electricity providers and/or aggregators, and/or charging station operators. FIG. 7 illustrates a non-limiting example of stakeholders and/or entities that may interact with an IEMS 100 consistent with various embodiments disclosed herein. For example, the IEMS 100 may interact with charging station owners, operators, and/or providers, IEMS owners and/or other authorized parties, IEMS family members and/or employees, which may be parties authorized to interact with the IEMS 100 based on policy set by the IEMS owner, electrical aggregators, providers, utilities, and/or the like.

External services 700-206 may also interact with the IEMS 100 during rule evaluation and execution and/or in connection with other operations of the IEMS 100. These external services may comprise, for example and without limitation, electricity pricing services 702, machine learning and/or AI services 704, trust services 706, weather services 700s, and/or the like

### Rules Execution Engine Rule Condition Evaluation

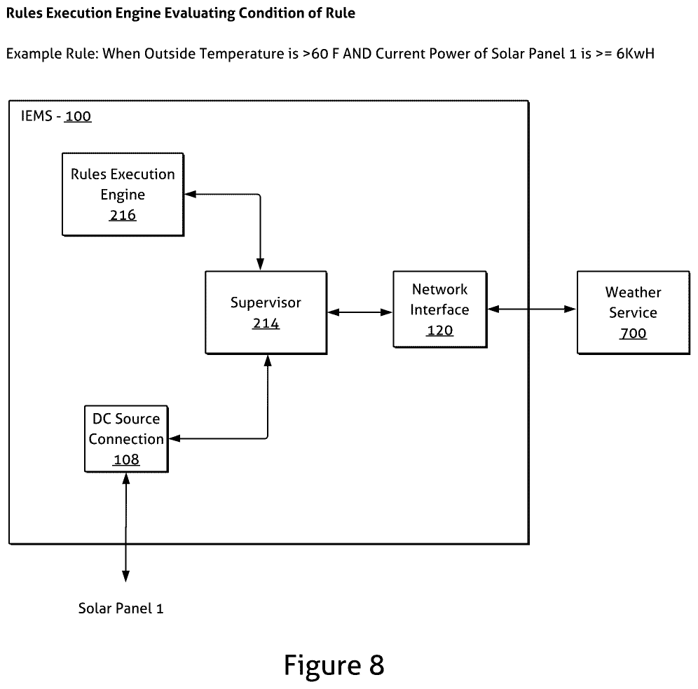

As discussed above, a rules execution engine may be used to evaluate rules and/or conditions and initialize execution of associated actions of the IEMS. FIG. 8 illustrates a non-limiting example of interactions initiated by a rules execution engine 216 consistent with certain embodiments disclosed herein. In the illustrated example, the rules execution engine 216 may evaluate a rule with the condition: “when outside-temperature>60 F AND current-power (solar-panel-1)>=6 Kw”. The rules execution engine make invoke the supervisor 214 of the IEMS 100 to determine the outside temperature. This may cause the supervisor 214 to send a request over the network interface 120 to an external weather service 700 to determine current weather conditions. In further embodiments, the IEMS 100 may be connected to a local weather station and/or sensors to provide more accurate location conditions, which may be used in lieu of and/or to supplement information provided by the external weather service 700. It may also cause the supervisor 214 to query its state, updated by the DC source connection 108, as to what the current power level is being provided by solar panel 1.

### IEMS Operation and Chained Sets of Rules

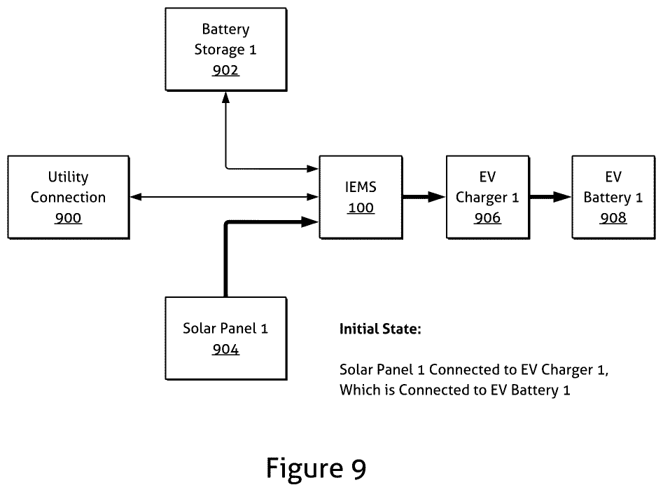

In various implementations, events can trigger operational rule execution, which can, in turn, trigger other events and/or rule execution in a chained configuration. FIG. 9 illustrates a non-limiting example of an initial state of a managed system consistent with certain embodiments disclosed herein. As illustrated, in an initial configuration, an IEMS 100 may connect a solar panel 904 to an EV charger 906 which may be connected to an EV battery 908. The managed system may further comprise a utility connection 900 and/or battery storage system 902 which may be coupled to the IEMS 100 but in a disconnected state. For example, as illustrated, the utility connection 900 may not be providing power to loads of the managed system via the IEMS 100 and/or the battery storage system 902 may be disconnected from any sources and loads.

In the non-limiting example, the following operational rules may be established:
Operational Rule 1: “when charge-level (ev-battery-1)>80%” THEN disconnect-sources (ev-charger-1) AND assert (event1)”.
Operational Rule 2: “when asserted (event1) AND source-connection (ev-charger-1)=disconnected” THEN connect (solar-panel-1, battery-stroage-1) AND assert (event2) AND unassert (event1)”.
Operational Rule 3: “when asserted (event2) AND charge-level (battery-storage-1)>90% THEN disconnect-sources (battery-storage-1) AND assert (event3) AND unassert (event2)”.
Operational Rule 4: “when asserted (event3) AND load-connection (battery-storage-1)=disconnected AND connection (solar-panel-1)=disconnected THEN connect (solar-panel-1, utility-connection) AND unassert (event3)”.

In various embodiments, when executing the chained operational rules detailed above, the following sequence may occur. When the charge level of EV-battery 908 is greater than 80%, disconnect any sources currently connected to EV charger 906. When EV charger 906 is known to be electrically disconnected from any sources or loads, connect solar panel 904 to battery storage 902. When the charge level of battery storage 902 is greater than 90%, disconnect all sources from the battery storage 902 (e.g., solar panel 904). When battery storage 902 and solar panel 904 are known to be electrically disconnected from any sources and loads, connect solar panel 904 to the utility-connection 900 (to feed generated electricity back into the grid).

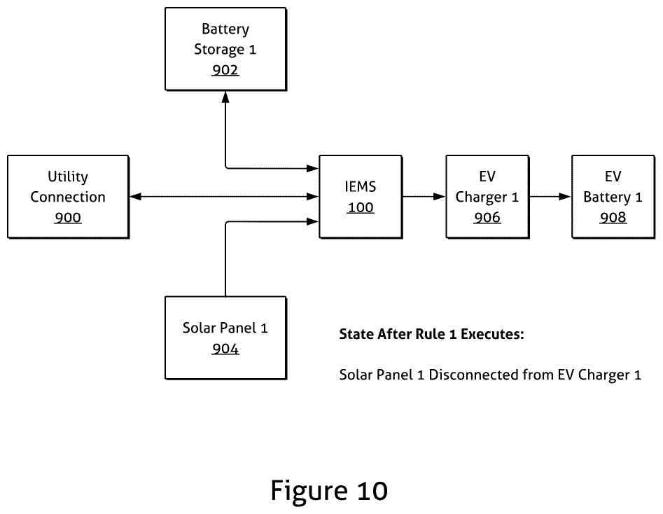

FIG. 10 illustrates a non-limiting example of a state of a managed system after executing the first operational rule consistent with certain embodiments disclosed herein. As shown, the IEMS 100 may engage in the following actions in connection with execution Operational Rule #1, resulting in the illustrated managed system configuration:
Rules engine queries supervisor for charge state of EV battery 908.
Supervisor queries source-combiner-redirector for charge state of EV battery 908.
Source-combiner-redirector queries AC connection for charge state of EV battery 908.
AC-connection queries EV charger 906 for charge state of EV battery 908.
Rules-engine compares charge state of EV battery 908 with 80% (from Operational Rule #1) and determines it is greater than 80%.
Rules-engine executes actions of triggered Operational Rule 1.
Rules-engine issues disconnect-sources through supervisor to source-combiner-redirector.
Source-combiner-redirector disconnects ac-connection-1 from EV charger 906.
Rules-engine triggers event 1.
When source-combiner-redirector detects that the disconnection has electrically occurred, supervisor state may be updated to reflect this configuration.

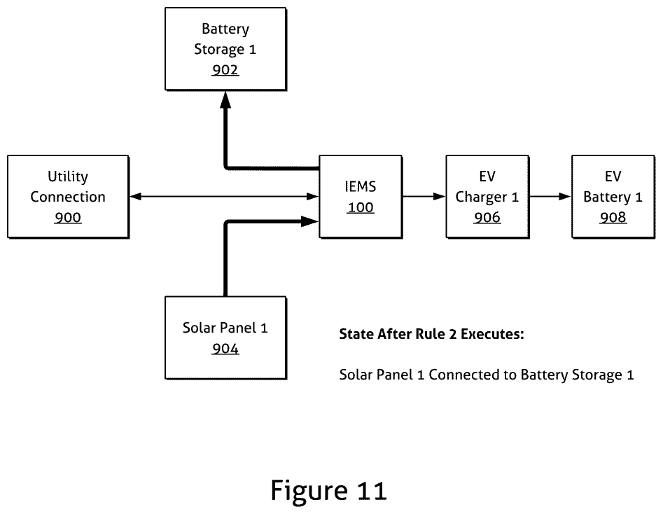

FIG. 11 illustrates a non-limiting example of a state of a managed system after executing a second operational rule consistent with certain embodiments disclosed herein. As shown, the IEMS 100 may engage in the following actions in connection with execution Operational Rule 2, resulting in the illustrated managed system configuration:
Rules-engine notices event1 triggered and queries supervisor state for connection state of EV charger 906 and finds it disconnected from the IEMS 100.
Rules-engine executes consequences of Operational Rule 2.
Rules-engine issues connect request to connect solar panel 904 to battery storage 902. It will be appreciated that in certain implementations, intermediate steps of a rules-engine coordinating with a supervisor, source combiner/redirector, AC connection actuation, and/or the like may occur in connection with this and other actions
Rules-engine triggers event2 and unasserts event1.
When source-combiner-redirector detects that the connection between solar panel 904 and battery storage 902 has been established (e.g., current flowing), it may update the supervisor state indicating this connection is active.

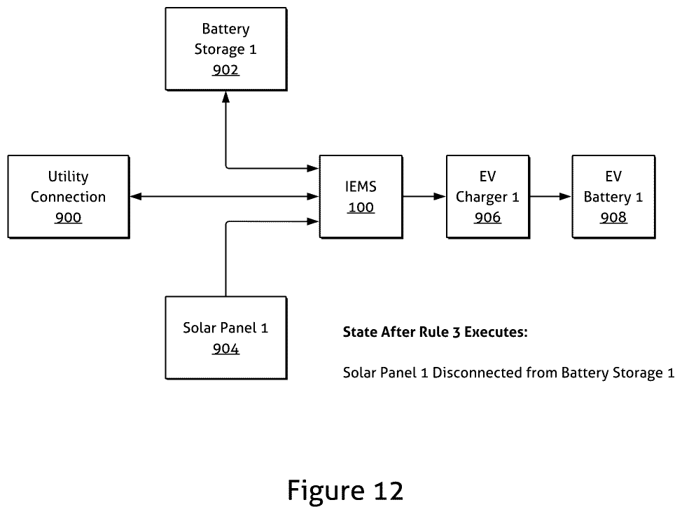

FIG. 12 illustrates a non-limiting example of a state of a managed system after executing a third operational rule consistent with certain embodiments disclosed herein. As shown, the IEMS 100 may engage in the following actions in connection with execution Operational Rule 3, resulting in the illustrated managed system configuration:
Rules-engine queries for charge state of battery storage 902.
Battery storage 902 responds with stage of charge indication; for example, 91%.
Rules-engine notices event2 triggered and that battery storage 902 is charged>90%, so it executes Operational Rule 3.
Rules-engine issues disconnect-sources operation to disconnect all sources from battery storage 902.
Rules-engine triggers event3 and unasserts event2.
Source-combiner-redirector disconnects all sources from battery storage 902 and updates supervisor state to reflect this. It may also update state to reflect that solar panel 906 is disconnected.

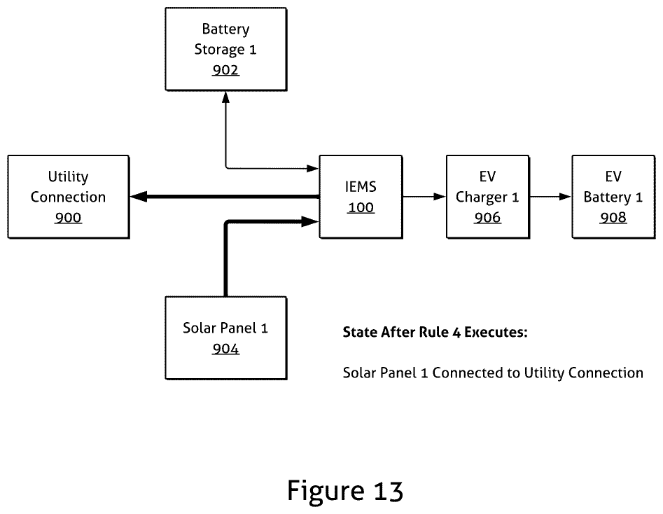

FIG. 13 illustrates a non-limiting example of a state of a managed system after executing a fourth operational rule consistent with certain embodiments disclosed herein. As shown, the IEMS 100 may engage in the following actions in connection with execution Operational Rule 4, resulting in the illustrated managed system configuration:
Rules-engine determines event3 has been triggered, that battery storage 902 is disconnected, and that solar panel 906 is disconnected, and executes Operational Rule 4.
Rules-engine issues connection request to connect solar panel 906 to utility-connection.
Rules-engine unasserts event3.

### IEMS Rule Execution Engine Execution

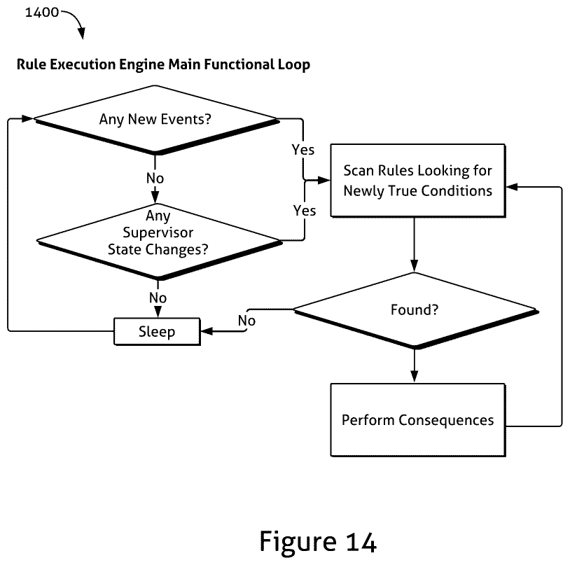

FIG. 14 illustrates a non-limiting example of the operation of an IEMS rule execution engine process 1400 consistent with certain embodiments disclosed herein. The illustrated operation may be implemented in a variety of ways, including using software, firmware, hardware, and/or any combination thereof. In certain embodiments, various aspects of the illustrated processes and/or its constituent steps may be performed by an IEMS and/or associated hardware and/or software components. Specifically, the process 1400 may be used to implement a main functional loop of an IEMS rule execution engine.

As shown, the rule execution engine may check (e.g., periodically check, continuously check, check based on event occurrences, check based on user command, etc.) for new events and/or event updates on the event bus. If no events are detected, the rules execution engine may check if there are any supervisor state changes. If none are detected, the IEMS and/or rules execution engine may remain in a sleep mode and/or continue to perform the aforementioned checks.

If new events and/or supervisor state changes have been detected, the rules execution engine may evaluate applicable rules to identify associated conditions. If applicable conditions are found, the IEMS may execute the associated condition actions and continue to check for actionable conditions until all applicable condition actions have been executed. If no applicable conditions are found, the IEMS may remain in a sleep mode and/or continue to check for event and/or supervisor state changes.

### IEMS Supervisor Anomaly Detection

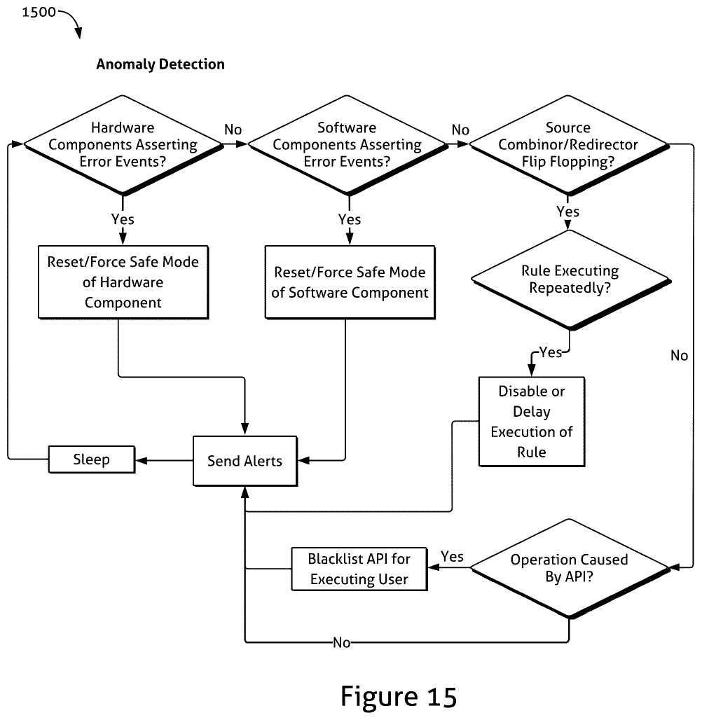

FIG. 15 illustrates a non-limiting example of anomaly detection operations 1500 by an IEMS supervisor consistent with certain embodiments disclosed herein. In certain embodiments, anomaly detection may run as a background task in the supervisor component of the IEMS software. It may check hardware and/or software components for any error events that these components experience when something anomalous occurs. If these components have detected an error (and signaled it to the supervisor, which has recorded it in its state), then the component may be first reset (to a known good state), and if the issue persists, the component may be put into a safe mode.

In certain embodiments, the safe mode may be component-dependent, but it may ensure that the component can no longer perform any changes to the IEMS or connected sources and/or loads. In addition, the supervisor may check to see if any source combiner/redirector module is rapidly changing state of any connections between sources and loads. If this is deleted, the cause may be investigated. This cause may be due to rule executions or due to API calls (including the calls to the API made via the management interface). In the case of rule executions, the offending rules may be disabled. In the case of API calls, the offending API call may be blacklisted for the currently executing user—that is, the user associated with the API call invocation. In some embodiments, this may not disable the API (e.g., operation) for all users-just the user making the API call. In further embodiments, the IEMS may introduce a delay in the execution of the offending rule(s) and trigger an alert to the owner to investigate the problem. The introduction of the delay may reduce the risk of damage to associated equipment while also giving users of the system time to respond and/or reconfigure rules. If the problem persists for an established time threshold, the IEMS may continue to progressively increase the delay in triggering one or more rules such that stability is restored to the system, or the delay associated with a rule may be progressively increased so as to effectively disable the rule. Such disabled or delayed rules may be suitably marked with warning indications in one or more views of management interface 200.

In any case, after an anomalous event is detected, an alert may be sent to the owner of the IEMS and any other authorized users for these alerts. These alerts may also be audited in the audit log.

### IEMS Example Use Cases

Embodiments of an IEMS as detailed herein may be used in a variety of use cases, applications, environments, energy generation, distribution, and/or delivery architectures, and/or contexts. In some embodiments, an IEMS may be customized, tailored, and/or otherwise configured based on its associated application, use case, environment, architecture, and/or context. For purposes of illustration and explanation, a number of illustrative example use cases implementing an IEMS are detailed below. It will be appreciated that these use cases are to be viewed as illustrative examples of the implementation of various embodiments of the disclosed systems and/or methods in certain contexts, and that the various embodiments disclosed herein are not to be considered as being limited to the detailed example use cases.

### Example Use Case-VPP and EVs

In at least one non-limiting illustrative example implementing embodiments of the disclosed systems and methods, Matilda is a 57-year-old grandmother who lives in Sacramento, CA. She recently purchased a Ford Mustang Mach E EV and opted for the extended range model, which can travel 379 miles on a single charge. She visits her son in San Luis Obispo once a year and doesn't want to deal with enroute charging of her car. Apart from this one-a-year long trip, she uses her car for grocery and household shopping in Sacramento. She rarely travels more than 20 miles a day.

Because Matilda never wants to be in a situation where she doesn't have enough charge when she wants to use her car, she has a home charger that keeps her car fully-charged every day of the year. For 11 months of the year, her charging needs are relatively minimal.

Recently, she signed up with a VPP so that the VPP could control the home charging station, keeping just enough charge in her EV for her daily shopping and diverting electricity to the grid in the heat of the hot Sacramento summers. She knows that prior to her trips to visit her son, she can prevent the VPP from controlling the charging and discharging of her EV and ensure that her EV is fully charged for her trip. At other times, Matilda is content to help the electricity grid in times of high demand. In return for the VPP's control over her charging station, she receives a rebate from her electricity provider. In addition, because she doesn't have to charge her car fully every evening, her electricity bills are lower.

### Example Use Case—VPP and Agriculture Operations

In another non-limiting illustrative example implementing embodiments of the disclosed systems and methods, George is a farmer who lives in Slater, Iowa. His farm is 1,400 acres and grows corn, soybeans, and assorted vegetables. His farm also produces milk from cows and beef from cattle. His irrigation needs are extensive, requiring multiple wells and well pumps. His milk and meat processing requires much equipment, which uses electricity. As his electricity costs have grown over the years, he has purchased solar panels and wind turbines to help augment the electricity he gets from the grid. He also has recently upgraded his farm vehicles to EVs. His farm runs year-round, but his greatest electricity needs are in the summer.

George signed up with a VPP to help manage his electrical consumption and to help provide electricity to the grid from his electricity producing equipment when he doesn't need all his capacity. Excess capacity from his solar panels and wind turbine is directed to the grid when it isn't needed on his farm. Of course, at any time, George can wrestle control away from the VPP and keep all his generated electricity when business needs demand. But due to his relationship with the VPP, he benefits from reduced electricity costs, rebates, and perks.

### Example Use Case—VPP and Fleet Operations

In another non-limiting illustrative example implementing embodiments of the disclosed systems and methods, Sarah is the CEO of Whatsit Enterprise, a car rental company based near Portland, OR. She has a fleet of 125 EV vehicles, which 6 months of the year is sufficient to meet the demands of travelers. 2 months of the year, 50 of her EVs sit fully charged on her lot, and 4 months of the year, she finds herself frequently out of cars and faces disgruntled customers who are turned away.

Sarah recently struck up a relationship with a VPP who, during periods of low vehicle demand, can direct electricity from her unused EVs to the electrical grid. That VPP offered to lease her an additional 25 vehicles, at very reasonable prices, in return for the ability to use the stored energy from these EVs in times of high energy demand, but when Sarah doesn't need the full fleet of 150 vehicles. She agrees to provide an agreed upon average amount of electrical energy to the VPP per year. The VPP monitors the amount of energy Sarah's company provides to the grid (as well as how much the company uses from the grid). Each year, if Sarah's company has provided approximately the agreed-upon amount of energy back to the grid, she gets to keep the cars, and have leases renewed and cars replaced as needed.

Sarah benefits from the additional 25 cars, which didn't cost her as much as her other 125 cars and is no longer out of cars as often. She also benefits from new cars being swapped out from the VPP, and the peace-of-mind of always having sufficient cars for her customers, but not having a surplus of cars (or the costs of keeping them charged) when demand for vehicles is low.

### Example Use Case—VPP and Rural Power Security

In another non-limiting illustrative example implementing embodiments of the disclosed systems and methods, Fred lives in the Santa Cruz Mountains. In times of winter storms, his power goes out frequently, as trees fall on electrical transmission wires. Because he lives in a relatively rural region, and there are only 15 customers on the segment that suffers from down wires, he usually must wait days before his power is restored. Fred took things into his own hands by purchasing several battery storage walls and an array of solar panels, which cover a large hillside on his property. He doesn't really need the batteries and solar panels most of the time because his energy needs are modest.

His relationship with his VPP is that he sends energy from his solar panels and batteries back to the grid most of the year. But when the winter storms come, he keeps all that stored energy for when his power goes out. In return for his contribution to the grid, he enjoys very low electrical costs. In times of high energy demand for the surrounding county, the VPP takes energy from Fred's electrical storage. This occurs mostly during the summer when the likelihood of power outages is low. In the winter, Fred has peace of mind knowing that he can power his house for a week or more from his solar panels and batteries.

### Example Use Case—EV Dealer Incentives

In another non-limiting illustrative example implementing embodiments of the disclosed systems and methods relating to EV dealer incentives, Khalil decides to join the clean energy wave and purchase an EV truck. He goes to his local Ford dealership and decides to buy a Ford F-150 Lightning with a Standard Range, 98.0 kWh battery. The dealer tells him that he should get about 230 miles out of a full charge. This is more than enough for Khalil, so he agrees to purchase the vehicle. The dealer, however, says “Have I got a deal for you!”. She says that she′ll upgrade Khalil's vehicle to the 131.0 kWh battery, with a range of 320 miles, for nothing. “What's the catch, says Khalil?”. The dealer explains that the additional charging costs to keep Khalil's F-150 charged will also be free, and he′ll only have to agree to allow the electrical grid to discharge his battery to the grid in times of heavy electrical demand. She explains that the grid will never allow the remaining charge to go any lower than what would be necessary for a 200-mile trip, and most of the time, there will be plenty of charge for longer trips. The dealer assures Khalil that should he know he needs the longer range; he can use his smart phone to place a hold on the grid's ability to discharge his F-150 battery. If this hold isn't extraordinarily long (e.g., 3+ weeks) or frequently (e.g., more than 3× year), no additional charges will be incurred. If, on the other hand, Khalil prevents the grid from using the battery above certain thresholds, a modest fee will be charged. Khalil thinks this is a pretty good deal and agrees.

In a similar non-limiting example, a rule can be set relating to EV charge levels with values that are more understandable, perceivable, and/or otherwise appreciated by a user than simply charge levels and/or charge percentages. For example, a user may be presented with an estimated range in miles or kilometers associated with a particular charge level. The IEMS (and/or an associated cloud service), may take into account one or more of the current health of the battery, the vehicle type, the user's driving habits, and/or current conditions (e.g., temperature, which may impact vehicle range).

### Example Use Case—VPP and EV Commuting

In another non-limiting illustrative example implementing embodiments of the disclosed systems and methods relating to EV commuting, Ruth has an EV and relies upon it to get to work. The charge on EV is sufficient to get her to work and most of the way home. She relies on an EV charger at work to charge her car sufficiently to get home. Both her EV and home charger, as well as her work's charger, are connected to a VPP. Machine learning algorithms at the VPP have learned that Ruth doesn't need to fully charge her car at work—most of the time, she only needs a small charge for her to get home, and sometimes run some short errands on her way home.

Ruth has allowed the VPP to control the charging of her vehicle at home and when at work to ensure she has ample charge in her EV to get her to and from work, and to accomplish her standard errands. It may not be necessary that her EV be fully charged all the time. In times of high energy demand (e.g., during the workday as opposed to when she's at home), the VPP can reduce the charge on her EV, and even discharge some of her charge to the grid, if necessary. In return for this flexibility, Ruth may receive discounts on her energy bill.

Consistent with embodiments disclosed herein, energy economies can be achieved due to cooperation and coordination from multiple charging stations. As in previous scenarios, should Ruth need to have a full charge for some non-standard driving either on her way to work or on her way home from work, she can use her smartphone to direct the chargers to fully charge her vehicle and not discharge any stored energy to the grid. Due to the connected nature of the EVs, charging stations, and smartphones, it is possible that in times of high demand, the VPP may send a message to Ruth asking her whether it can reduce her charge or discharge her EVs battery to the grid, and to what extent.

### Example Use Case—Multiple EV Charging Stations

In a further non-limiting illustrative example implementing embodiments of the disclosed systems and methods relating to multiple EV charging stations, Franny owns an EV and has a personal charging station connected to her IEMS at home. She charges her EV at night, so that she has sufficient charge to get to work, possibly running some errands while traveling to and from work. When she arrives at her office, she plugs her EV into a charging station at her office. Her company does not provide free charging, so she must pay at the office charging station for any electricity she uses to charge her vehicle. She engages in a balancing act to play regarding how much charge she charges her battery at home and how much she charges at work. If she fully charges her battery at work, she may only have to do a catch-up charge at home to be ready to commute to work the next day.

In this scenario, the charging station at work may be part of a network of charging stations with API interfaces that may allow an IEMS consistent with certain disclosed embodiments to communicate with the remote charging station (as well as her charging station at home). Commands can control the extent of a charge at either charging station, the desired battery capacity, and whether rapid or slower charging is employed.

In certain embodiments, pricing information may be utilized by an IEMS associated with multiple charging stations. For example and without limitation, if the IEMS receives pricing information that power will be cheaper tomorrow (at both Franny's home and at work, say), then it can decide to charge the EV battery at a level to allow Franny to get to work (and perform her errands). That way, Franny's EV can charge at the work charger when electricity is cheaper, and the IEMS can instruct the work charger to fully charge the EV (when prices are cheap). The inverse is also possible—if power will be more expensive tomorrow, the IEMS can instruct the home charger to fully charge the vehicle so that a smaller catch-up charge at work tomorrow will result in a cheaper energy bill.

A similar scenario can apply if energy is always cheaper, or comes from renewable sources (if desired) at one chargepoint or another, but it is more of a benefit if there is variability in costs/sources, and the IEMS can leverage its intelligence to make appropriate decisions. If IEMS control over remote chargers is not available, alerts can be sent to Franny to let her know to adjust her work charger schedule/capacity to benefit her financially.

In this manner, an IEMS may, though executing and/or otherwise implementing operational rules, direct and/or manage EV charging based on user behavior, preferences, and/or pricing and/or other information across personal charging system(s) and/or charging networks available to the public. Pricing information, availability information, information relating to a type of associated supplied energy (e.g., clean and/or renewable generated energy), user preference information relating to EV charging (e.g., user specified preference information, station location preference information, which may be identified by monitoring user behavior/location, etc.), and/or the like may be received by an IEMS and used in connection with defining and/or executing applicable operational rules. Among other things, this may facilitate more intelligent charging of an EV by home charger and across a broader network of charging stations.

In various embodiments, trained AI and/or machine learning models may be used to identify patterns and/or behaviors of a user and/or their use of an EV. For example, in some embodiments, a trained AI model may use information relating to a user's location (and/or their vehicle's location) at certain times of day to identify a user's home, place of work, and/or other commonly visited destinations. User provided information may be further used in model training (e.g., home address, work address, charging preferences, etc.) In this manner, the model may develop a relatively accurate prediction of a user's behavior pattern on a given day.

The AI model may further be trained using available pricing information at charging stations associated with various user destinations (e.g., home, work, etc.). Based on this available training information, an intelligent model for charging an EV may be developed. For example and without limitation, the model may identify that the most cost-efficient manner for a user to charge their EV is to charge to 35% of capacity at home at standard utility rates, and then later charge to 65% at their workplace where energy may be subsidized by their employer, allowing sufficient charge for the user to run after work errands and return home. User preferences relating to energy generation type (e.g., renewable energy) may also be accounted for in the model. An IEMS device associated with the user at home, or an associated IEMS service may use this model information to coordinate charging of the EV at home, potentially sending signals to the user's EV and/or other charging stations and/or networks to coordinate remote charging operations, which may include specified charging levels and/or scheduling message to reserve charging availability. In this manner, more intelligent charging of an EV by home charger and across a broader network of charging stations may be realized. In some embodiments, a user may be able to view and/or override charging schedules coordinated by an AI model via an IEMS interface if desired.

In further embodiments, personal agents and/or AIs may also be used by a trained model to identify optimal charging schedules (e.g., charge times and/or charge levels) for a vehicle. For example a personal AI agent may identify based on messages received in a user's email that they have an approaching road trip and/or flight. This information may be shared with the IEMS (and/or another AI model in communication with the IEMS), which may then adjust charging schedules and/or levels to accommodate the upcoming planned travel. For example and without limitation, the IEMS may determine that a vehicle should be charged to full capacity before the road trip and/or at a level that allows for travel to the airport (and potentially back if the airport does not have available charging locations).

### Example Use Case—Renewable Energy Preference

Jeff is very concerned about the environment, and in particular wants to leverage grid energy when the source of that energy is renewable, and not when it comes from fossil fuel sources. He has an IEMS with connections to the grid, as well a storage battery and an EV charger. His electrical grid provider provides a real-time feed indicating the percentage of electricity that comes from the nearby solar farm versus from the natural gas plant. This feed is available as a web service, and Jeff has used an IEMS software plugin that allows IEMS operational rules to use this information in decisions. When the energy supply is largely generated from natural gas, the IEMS may stop charging his batteries, and direct his storage battery to discharge, largely powering his home. During this time, unless his EV battery is too low for comfort, it may also not be charged from the grid. The IEMS sends an alert to Jeff via his smart phone, so that Jeff can take great care to use a minimal amount of energy in his house.

However, when the weather is favorable for generation from renewable sources, and his electricity provider is using renewable energy sources and in particular solar energy, the IEMS detects this, and may use the energy to charge up the storage battery, the EV battery, and of course, to power Jeff's home. The IEMS may also send Jeff a message on his smart phone indicating that he is enjoying renewable energy, and Jeff may beam a happy smile.

### Example Use Case—Energy Oversupply

Elena lives in Switzerland, where occasionally there is an oversupply of renewable energy. That is, the energy demands are not high enough to leverage all of the available renewable energy. When this happens, the electrical grid simply does not draw from these renewable sources, and consequently does not pay the renewable energy suppliers. The excess solar and wind energy would otherwise go wasted. However, the dominant wind energy supplier in Elena's region has engaged with residents, including Elena, to have storage batteries installed, at minimal or no-cost, in the residents' homes. Normally, these batteries are kept minimally charged and are not being leveraged for stored energy. However, in situations where an oversupply of renewable energy exists, a web service commissioned by the wind energy supplier, provides signals to IEMS devices in the region. Operational rules in the IEMS devices, direct the IEMS to connect the storage batteries to the grid for charging. This cause-and-effect may be recorded in audit records by the IEMS—in other words, an audit record is generated that indicates that customer started charging batteries as a direct result of the oversupply signal. While the batteries are charging from the grid, the IEMS captures periodic energy usage from the charging of the batteries and generates audit records. Finally, when the batteries are fully charged, audit records capture that charging has stopped. These audit records are sent by the IEMS to the renewable energy provider, as well as the grid operator. They attest that this artificial demand was a direct result of the renewable energy oversupply.

The fact that the renewable energy provider has contributed to increasing demand, even when, perhaps, energy from that specific provider was not being used to charge Elena's (and her neighbors') batteries, is noted by the grid operator, and used to increase the likelihood that that renewable energy provider should be used preferentially in the future (as opposed to, say, other renewable energy providers who haven't shown a track record for being able to increase demand).

Elena and those with similar arrangements benefit by being able to discharge stored energy into their homes or back into the grid to lower their electrical costs. The renewable energy providers benefit by having proven their ability to increase demand in times of energy oversupply. And the grid operator benefits by knowing they can have a reliable partner in the renewable energy provider.

### Example Use Case—Government Push for Renewables

A US state government, like that of the state of South Dakota, may be committed to using renewable energy and not letting renewable energy go to waste. As in the previous scenario, this government may leverage the capabilities of installed IEMS systems in homes and businesses to help enforce their policy of “renewable energy first”. This government policy dictates to the electrical utility that it must use renewable energy to the maximum extent possible, and at the expense of fossil fuel-based energy providers. If any renewable energy provider can provide proof that they are bringing on demand, the utility is required to buy marginal kWh of energy from them. Installed storage batteries attached to IEMS, as in the previous scenario, can be charged up on demand, through commands (and IEMS operational rules) from the renewable providers. The trusted audit records generated by the IEMS attesting that the added demand is a direct result of actions by the renewable providers, can provide the proof needed to dictate that utilities must purchase energy from the renewable providers.

While this scenario may be similar to the previous scenario in some respects, it encapsulates an aggregation of micro-decisions, which may be insignificant when taking individually, but when taken as a whole may have significant implications for the leveraging of renewable energy (over fossil energy). Aggregators and grid providers, through the trusted audit records of many IEMS devices, can use this information to make large-scale grid-level changes to the advantage of renewable energy sources.

Note that in this scenario, the energy is moved from renewable providers to storage batteries connected to IEMS devices in the region. It is not being used to power homes in real-time. However, when renewable sources are undersupplying demand, such as at night when solar energy is not available, or during times of low wind, where wind turbines are not churning out power, these storage batteries can be directed to discharge into the home or back into the grid.

### Example Use Case: Using Learned Behavior to Improve Use of Energy in Stored in Connected Home Appliance

In a further non-limiting illustrative example, the IEMS may use learned behaviors to suggest and/or establish control rules that allow the IEMS, in communication with suitably enabled appliances in the home, to gain optimal use of energy that may be stored in association with these appliances. In an effort to reduce their reliance on fossil fuel and improve their indoor air quality, homeowners John and Avril have decided to replace their gas stove with a new induction cooktop. To save money and avoid the hassle associated with installing a higher amp-rated circuit to their kitchen, they have opted for a model that incorporates an associated storage battery that charges itself using their existing lower amp-rated circuit during times of non-use and provides an extra source of power to the appliance during the high demands of operation. John used the money he saved by not running a new circuit for the cooktop to instead install an IEMS for the home and configured the new induction cooktop to be able to communicate with the IEMS to assist in controlling its energy storage system.

When such a device is connected to the IEMS via, for example, a Matter-based network connection, the IEMS can control the discharge and use of the energy stored in the device based on pre-established rules and/or rules derived from learned user behavior. The IEMS system may receive usage data (e.g., from sensors associated with the circuit that the cooktop is connected to, or via communications received from the device using a Matter connection) that may be used to determine usage behavior of the appliance by members of the household. Using this data, a machine learning algorithm incorporated in the IEMS (or via an associated web service) may determine that the cooktop is rarely or never used on weekdays before 4:30 PM or after 8 PM. The IEMS system may also receive information indicating the percentage of the grid-supplied power that is derived from renewable energy sources throughout the day. Using this information, the IEMS may suggest rules that enable the remaining energy stored in the cooktop's battery (after 8 PM in this example) to be discharged to supply energy to meet some or all of the home's power demands during the evening, thereby reducing the home's load during times when power is known to be largely comprised of non-renewable sources. The following morning, when renewable sources are plentiful, the IEMS rules may switch the portions of the home that were powered by the cooktop back to grid power, and communicate to the cooktop that it may begin charging (using the relatively larger share of renewable power available during the day) and is able to provide sufficient power requirements for cooking dinner that evening. In such a manner, the IEMS, working together with suitably configured appliances in the home can serve to “time-shift” at least a portion of a household's energy consumption from fossil fuels to renewables by intelligently analyzing behavior, suggesting rules, and performing switching controls of connected loads and sources.

### Energy System Management and Operational Rule Execution

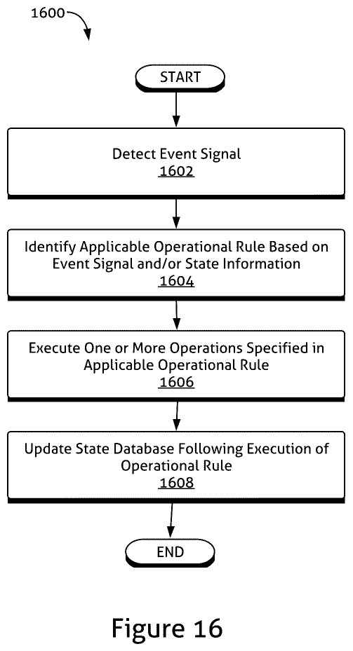

FIG. 16 illustrates a flow chart of a non-limiting example of a method 1600 of managing an energy system consistent with certain embodiments disclosed herein. The illustrated method 1600 may be implemented in a variety of ways, including using software, firmware, hardware, and/or any combination thereof. In certain embodiments, various aspects of the method 1600 and/or its constituent steps may be performed by a service, system, and/or device configured to implement embodiments of an IEMS consistent with the disclosed embodiments.

At 1602, at least one event signal may be detected by a rules execution engine of the IEMS. In some embodiments, the IEMS may receive the at least one event signal from a local sensor, system, device, and/or interface. In further embodiments, the IEMS may receive the at least one event signal from an external source. For example and without limitation, in some embodiments, the at least one event signal may comprise weather information received from a weather service. In further embodiments, the event signal may comprise energy pricing information, information received from a machine learning service provider, and/or the like.

The rules execution engine may identify at least one operational rule based on the at least one event signal at 1604. In certain embodiments, the at least one operational rule may specify and/or otherwise articulate one or more conditions associated with the at least one event signal and one or more operations associated with at least one managed object. In this manner, a condition may be triggered by an event signal, which when triggered may invoke an associated operation. In further embodiments, operational rules may be identified based on IEMS state information (e.g., in a state database).

Managed objects may comprise one or more electrical sources and/or loads. In some embodiments, an electrical source may comprise a utility provider connection and/or source (e.g., a grid source) or a local electrical source such as, for example and without limitation, a battery storage system, a generator system, an EV battery system, and/or the like. A variety of electrical loads may be managed in connection with the disclosed embodiments including, for example and without limitation, an EV charger, a battery storage system (which indeed may, depending on its configuration, function as either a source and/or a load), an electrical appliance, and/or the like.

At 1606, the one or more operations specified in the at least one operational rule may be executed, at least in part, by the rules execution engine. In some embodiments, executing the one or more operations may comprise actuating an electrical connection associated with the at least one managed object (e.g., disconnecting and/or connecting associated sources and/or loads) by the IEMS. For example, in some embodiments, the IEMS rules execution engine may issue a control signal to energy combiner/redirector hardware, which may be configured to actuate the electrical connection associated with the at least one managed object based on the control signal. In certain embodiments, a state database managed by the IEMS system may be updated at 1608 in response to executing the one or more operations.

### High Level System Architecture

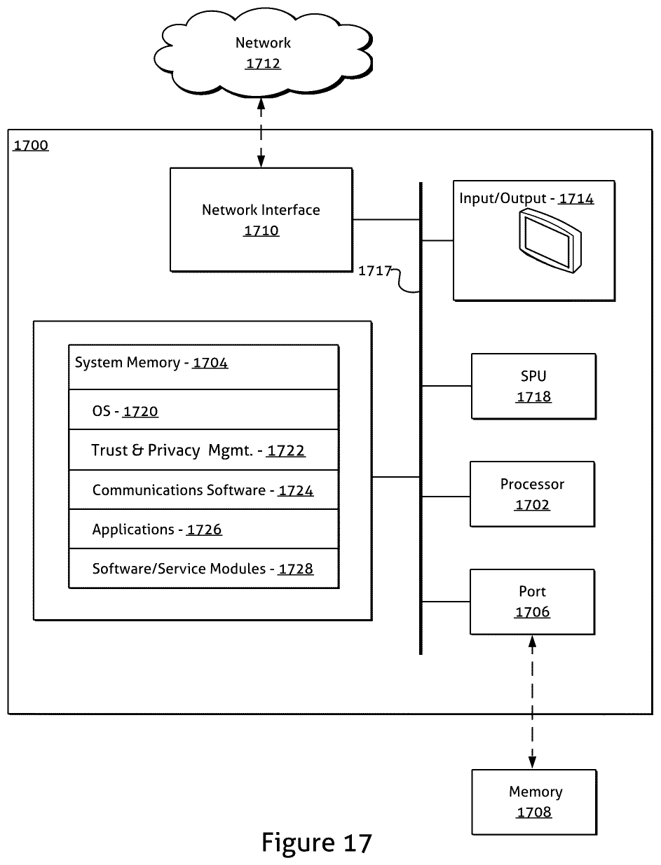

FIG. 17 illustrates an example of a system 1700 that may be used to implement certain embodiments of the systems and methods of the present disclosure. The system 1700 of FIG. 17 and/or aspects thereof may be included in any system, service, device, and/or component configured to implement embodiments of the disclosed systems and methods and/or aspects thereof. For example, the system 1700 and/or aspects thereof may be used to implement an IEMS consistent with embodiments disclosed herein.

The various systems and/or devices used in connection with aspects the disclosed embodiments may be communicatively coupled using a variety of networks and/or network connections (e.g., network 1712). In certain embodiments, the network 1712 may comprise a variety of network communication devices and/or channels and may utilize any suitable communications protocols and/or standards facilitating communication between the systems and/or devices.

The network 1712 may comprise the Internet, a local area network, a virtual private network, and/or any other communication network utilizing one or more electronic communication technologies and/or standards (e.g., Ethernet or the like). In some embodiments, the network 1712 may comprise a wireless carrier system such as a personal communications system (“PCS”), and/or any other suitable communication system incorporating any suitable communication standards and/or protocols. In further embodiments, the network 1712 may comprise an analog mobile communications network and/or a digital mobile communications network utilizing, for example, code division multiple access (“CDMA”), Global System for Mobile Communications or Groupe Special Mobile (“GSM”), frequency division multiple access (“FDMA”), and/or time divisional multiple access (“TDMA”) standards. In certain embodiments, the network 1712 may incorporate one or more satellite communication links. In yet further embodiments, the network 1712 may utilize IEEE's 802.11 standards, Bluetooth®, ultra-wide band (“UWB”), Zigbee®, and or any other suitable standard or standards.

The various systems and/or devices used in connection with aspects of the disclosed embodiments may comprise a variety of computing devices and/or systems, including any computing system or systems suitable to implement the systems and methods disclosed herein. For example, the connected devices and/or systems may comprise a variety of computing devices and systems, including laptop computer systems, desktop computer systems, server computer systems, distributed computer systems, smartphones, tablet computers, and/or the like.

In certain embodiments, the systems and/or devices may comprise at least one processor system configured to execute instructions stored on an associated non-transitory computer-readable storage medium. As discussed in more detail below, systems used in connection with implementing various aspects of the disclosed embodiments may further comprise a secure processing unit (“SPU”) configured to perform sensitive operations such as trusted credential and/or key management, cryptographic operations, secure policy management, and/or other aspects of the systems and methods disclosed herein. The systems and/or devices may further comprise software and/or hardware configured to enable electronic communication of information between the devices and/or systems via a network using any suitable communication technology and/or standard.

As illustrated in FIG. 17, the example system 1700 may comprise: a processing unit 1702; system memory 1704, which may include high speed random access memory (“RAM”), non-volatile memory (“ROM”), and/or one or more bulk non-volatile non-transitory computer-readable storage mediums (e.g., a hard disk, flash memory, etc.) for storing programs and other data for use and execution by the processing unit 1702; a port 1706 for interfacing with removable memory 1708 that may include one or more diskettes, optical storage mediums (e.g., flash memory, thumb drives, USB dongles, compact discs, DVDs, etc.) and/or other non-transitory computer-readable storage mediums; a network interface 1710 for communicating with other systems via one or more network connections and/or networks 1712 using one or more communication technologies; a user interface 1714 that may include a display and/or one or more input/output devices such as, for example, a touchscreen, a keyboard, a mouse, a track pad, and the like; and one or more busses 1716 for communicatively coupling the elements of the system.

In some embodiments, the system 1700 may, alternatively or in addition, include a trusted execution environment and/or an SPU 1718 that is protected from tampering by a user of the system or other entities by utilizing secure physical and/or virtual security techniques. A trusted execution environment and/or a SPU 1718 can help enhance the security of sensitive operations such as personal information management, trusted credential, token, and/or key management, privacy and policy management, and other aspects of the systems and methods disclosed herein. In certain embodiments, the trusted execution environment and/or SPU 1718 may operate in a logically secure processing domain and be configured to protect and operate on secret information, as described herein. In some embodiments, the trusted execution environment and/or a SPU 1718 may include internal memory storing executable instructions or programs configured to enable the SPU 1718 to perform secure operations, as described herein.

The operation of the system 1700 may be generally controlled by the processing unit 1702 and/or an SPU 1718 operating by executing software instructions and programs stored in the system memory 1704 (and/or other computer-readable media, such as memory 2208, which may be removable). The system memory 1704 may store a variety of executable programs or modules for controlling the operation of the system. For example, the system memory may include an operating system (“OS”) 1720 that may manage and coordinate, at least in part, and/or system hardware resources and provide for common services for execution of various applications.

The system memory 1704 may further include, for example and without limitation, trust and privacy management functionality 1722 including protection and/or management of private and/or otherwise sensitive data through management and/or enforcement of associated policies, communication software 1724 configured to enable in part communication with and by the system 1700, one or more applications 1726, one or more software and/or service modules 1728 detailed herein configured to implement IEMS functionality and/or aspects thereof, and/or any other information, modules, and/or applications configured to implement embodiments of the systems and methods disclosed herein.

The systems and methods disclosed herein are not inherently related to any particular computer, electronic control unit, or other apparatus and may be implemented by a suitable combination of hardware, software, and/or firmware. Software implementations may include one or more computer programs comprising executable code/instructions that, when executed by a processor, may cause the processor to perform a method defined at least in part by the executable instructions. The computer program can be written in any form of programming language, including compiled or interpreted languages, and can be deployed in any form, including as a standalone program or as a module, component, subroutine, or other unit suitable for use in a computing environment. Further, a computer program can be deployed to be executed on one computer or on multiple computers at one site or distributed across multiple sites and interconnected by a communication network.

Software embodiments may be implemented as a computer program product that comprises a non-transitory storage medium configured to store computer programs and instructions, that when executed by a processor, are configured to cause the processor to perform a method according to the instructions. In certain embodiments, the non-transitory storage medium may take any form capable of storing processor-readable instructions on a non-transitory storage medium. A non-transitory storage medium may be embodied by a compact disk, digital-video disk, a magnetic disk, flash memory, integrated circuits, or any other non-transitory digital processing apparatus memory device.

Although the foregoing has been described in some detail for purposes of clarity, it will be apparent that certain changes and modifications may be made without departing from the principles thereof. It should be noted that there are many alternative ways of implementing both the systems and methods described herein. Accordingly, the present embodiments are to be considered as illustrative and not restrictive, and the invention is not to be limited to the details given herein but may be modified with the scope and equivalents of the appended claims.

1. A method of managing an energy system performed by an intelligent energy management system, the method comprising:
detecting, by a rules execution engine executing on the intelligent energy management system, at least one event signal;
identifying, by the rules execution engine, based on the at least one event signal, at least one operational rule, the at least one operational rule specifying one or more conditions associated with the at least one event signal and one or more operations associated with at least one managed object, the at least one managed object comprising at least one of an electrical source and an electrical load;
executing, at least in part by the rules execution engine, the one or more operations specified in the at least one operational rule, wherein executing the one or more operations comprises actuating an electrical connection associated with the at least one managed object; and
updating a state database managed by the intelligent energy management system in response to executing the one or more operations.

2. The method of claim 1, wherein executing the one or more operations comprises:
issuing, by the rules execution engine to energy combiner and redirector hardware of the intelligent energy management system, a control signal;
wherein the energy combiner and redirector hardware is configured to actuate the electrical connection associated with the at least one managed object based on the control signal.

3. The method of claim 1, wherein at least one condition of the one or more conditions is associated with intelligent energy management system state information.

4. The method of claim 3, wherein identifying the at least one operational rule is further based on at least one entry in the state database managed by the intelligent energy management system.

5. The method of claim 1, wherein the electrical source comprises a utility provider connection.

6. The method of claim 1, wherein the electrical source comprises a local electrical source.

7. The method of claim 1, wherein the local electrical source comprises one or more of a battery storage system, a generator system, and an electric vehicle battery system.

8. The method of claim 1, wherein the electrical load comprises one or more of an electric vehicle charger, a battery storage system, and an electric appliance.

9. The method of claim 1, wherein the method further comprises receiving, by the intelligent energy management system, the at least one event signal.

10. The method of claim 9, wherein the at least one event signal comprises an external event signal.

11. The method of claim 10, wherein the external event signal comprises weather information.

12. The method of claim 11, wherein the external event signal is received from a weather service.

13. The method of claim 10, wherein the external event signal comprises energy pricing information.

14. The method of claim 10, wherein the external event signal is received from a machine learning service provider.

15. The method of claim 9, wherein the at least one event signal comprises a signal provided by a user of the intelligent energy management service.

16. The method of claim 1, wherein actuating the electrical connection associated with the at least one managed object comprises electrically connecting the electrical source to the intelligent energy management system.

17. The method of claim 1, wherein actuating the electrical connection associated with the at least one managed object comprises electrically disconnecting the electrical source from the intelligent energy management system.

18. The method of claim 1, wherein actuating the electrical connection associated with the at least one managed object comprises electrically connecting the electrical load to the intelligent energy management system.

19. The method of claim 1, wherein actuating the electrical connection associated with the at least one managed object comprises electrically disconnecting the electrical load from the intelligent energy management system.
